(19) United States
(12) Patent Application Publication
(10) Pub. No.: US 2009/0220877 A1
(43) Pub. Date: Sep. 3, 2009

(54) PHOTOCURABLE COMPOSITION, OVERPRINT, AND PRODUCTION PROCESS THEREFOR

(75) Inventor: Ryuki KAKINO, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/392,407

(22) Filed: Feb. 25, 2009

(30) Foreign Application Priority Data
Feb. 29, 2008 (JP) 2008-049260

(51) Int. Cl. G03G 5/14; G03G 13/00

(52) U.S. Cl. 430/66; 430/126.1; 430/104

(57) ABSTRACT

A process for producing an overprint is provided, the process including a step of preparing a printed material by printing on a printing substrate, a step of coating the printed material with a photocurable composition, and a step of photocuring the photocurable composition, the photocurable composition comprising (A) a polymerizable group-containing photopolymerization initiator and (B) a polymerizable compound. There are also provided an overprint produced by the process for producing an overprint, and a photocurable composition that includes (A) a polymerizable group-containing photopolymerization initiator and (B) a polymerizable compound.

### BACKGROUND OF THE INVENTION

1. Field of the Invention

The present invention relates to a photocurable composition, and to an overprint and a process for producing same. More particularly, the present invention relates to a photocurable coating composition that is curable upon exposure to actinic radiation such as an electron beam or UV rays. In particular, it relates to a photocurable coating composition for coating an image formed by depositing ink and/or toner on a printing substrate (image receiving substrate) by a method such as lithography, relief printing, intaglio printing, screen printing, inkjet, or electrophotography. More particularly, it relates to a photocurable overprint composition (overprint composition) particularly suitably used for coating a toner-based printed material printed by an electrophotographic process.

2. Description of the Related Art

In recent years, a large number of actinic radiation curable compositions that can be used in UV curable printing inks, paints, and coatings have been developed, and the spreading thereof is currently being promoted. However, it is at present difficult to obtain a photocurable composition that satisfies all requirements in terms of curability, surface smoothness, strength, storage stability, etc.

In particular, when a layer of fuser oil is present on the surface of a toner-based image such as one obtained by an electrophotographic process, it is yet more difficult to obtain desired performance.

In a standard method for forming a toner-based image, such as an electrophotographic process, an electrostatic charge is formed on a latent image retaining surface by uniformly charging a latent image retaining surface such as, for example, a photoreceptor. Subsequently, charge on the uniformly charged region is selectively released by a pattern of activation irradiation corresponding to an original image. The latent image charge pattern remaining on the surface corresponds to regions that have not been exposed to radiation. Subsequently, the photoreceptor is passed through one or a plurality of development housings containing toner, and since the toner is deposited on the charge pattern by electrostatic attractive force, the latent image charge pattern is visualized. Subsequently, the developed image is either fixed on an image-forming surface or transferred to a printing substrate such as, for example, paper and fixed thereto by an appropriate fixation technique, thus giving an electrophotographically printed material, that is, a toner-based printed material.

As a known method for protecting a printed material, applying an overprint coating to the printed material has been proposed. For example, JP-A-11-70647 and JP-A-2003-241414 (JP-A denotes a Japanese unexamined patent application publication) propose a method such as an electrophotographic process, in which fixation is carried out after a transparent toner is transferred on top of a toner-based image, thus covering the surface.

Furthermore, JP-A-61-210365 proposes a method in which an overprint coating is applied by applying a liquid film coating that is curable by UV rays, etc. and polymerizing (crosslinking) a coating component by means of light.

Furthermore, JP-A-2005-321782 discloses an overprint composition comprising a radiation curable oligomer selected from the group consisting of trifunctional unsaturated acrylic resins, a radiation curable monomer selected from the group consisting of polyfunctional alkoxylated acrylic monomers and polyalkoxylated acrylic monomers, such as one type or a plurality of types of diacrylate or triacrylate, at least one type of photopolymerization initiator, and at least one type of surfactant.

Furthermore, as a polymerization initiator, those below are known.

JP-A-7-33811 discloses a photoinitiator obtained by an esterification reaction of a carboxylic acid-containing addition-polymerized polymer having a weight-average molecular weight of at least 5000 with a hydroxy group-containing phenyl ketone compound.

Moreover, JP-A-2-270844 discloses a copolymerizable phenone derivative.

Furthermore, JP-A-2002-207293 discloses a heat mode-compliant lithographic printing plate precursor comprising, above a support, a photosensitive layer comprising (A) a photothermal conversion agent, (B) a polymerizable unsaturated group-containing compound, and (C) a polymerizable unsaturated group-containing photo- or thermo-polymerization initiator, the photosensitive layer being recordable by a heat mode laser.

### BRIEF SUMMARY OF THE INVENTION

It is an object of the present invention to provide a photocurable composition giving excellent surface smoothness, non-tackiness (suppression of surface tackiness), and suppression of odor, an overprint obtained by using the photocurable composition, and a process for producing same.

The above object has been attained by (1), (10), or (11). They are described below together with (2) to (9) and (12) to (15), which are preferred embodiments.
(1) A process for producing an overprint, the process comprising:

a step of preparing a printed material by printing on a printing substrate;

a step of coating the printed material with a photocurable composition; and

a step of photocuring the photocurable composition;

the photocurable composition comprising (A) a polymerizable group-containing photopolymerization initiator and (B) a polymerizable compound.
(2) The process for producing an overprint according to (1), wherein the polymerizable group of the polymerizable group-containing photopolymerization initiator (A) is an ethylenically unsaturated bond and/or a cyclic ether group.
(3) The process for producing an overprint according to (1), wherein the polymerizable group-containing photopolymerization initiator (A) is a compound selected from the group consisting of an onium salt compound, a borate salt compound, an imide structure-containing compound, a triazine structure-containing compound, an azo compound, a peroxide, and a lophine dimer structure-containing compound.
(4) The process for producing an overprint according to (1), wherein the polymerizable group-containing photopolymerization initiator (A) is a compound selected from the group consisting of an onium salt compound, an imide structure-containing compound, and a triazine structure-containing compound.
(5) The process for producing an overprint according to (1), wherein the photocurable composition has substantially no absorption in the visible region.
(6) The process for producing an overprint according to (1), wherein the printing is electrophotographic printing, and the printed material is an electrophotographically printed material.
(7) The process for producing an overprint according to (6), wherein the electrophotographically printed material is an electrophotographically printed material having a fuser oil layer.
(8) The process for producing an overprint according to (1), wherein the amount of cured photocurable composition formed on the printed material is 1 to 10 g/m².
(9) The process for producing an overprint according to (1), wherein the photocurable composition cured on the printed material has a thickness of 1 to 10 μm.
(10) An overprint produced by the process for producing an overprint according to (1). (11) A photocurable composition comprising:

(A) a polymerizable group-containing photopolymerization initiator; and

(B) a polymerizable compound.
(12) The photocurable composition according to (11), wherein the polymerizable group of the polymerizable group-containing photopolymerization initiator (A) is an ethylenically unsaturated bond and/or a cyclic ether group.
(13) The photocurable composition according to (11), wherein the polymerizable group-containing photopolymerization initiator (A) is a compound selected from the group consisting of an onium salt compound, a borate salt compound, an imide structure-containing compound, a triazine structure-containing compound, an azo compound, a peroxide, and a lophine dimer structure-containing compound.
(14) The photocurable composition according to (11), wherein the polymerizable group-containing photopolymerization initiator (A) is a compound selected from the group consisting of an onium salt compound, an imide structure-containing compound, and a triazine structure-containing compound.
(15) The photocurable composition according to (11), wherein it has substantially no absorption in the visible region.

### DETAILED DESCRIPTION OF THE INVENTION

The present invention is explained in detail below.

### Photocurable Composition

The photocurable composition (hereinafter, also called a ‘photocurable coating composition’, a ‘photocurable overprint composition’, or simply a ‘coating composition’) of the present invention comprises (A) a polymerizable group-containing photopolymerization initiator and (B) a polymerizable compound.

The overprint of the present invention has an overprint layer on an electrophotographically printed material, the overprint layer being formed by photocuring the photocurable coating composition.

The process for producing an overprint of the present invention comprises a step of preparing a printed material by printing on a printing substrate, a step of coating the printed material with a photocurable composition, and a step of photocuring the photocurable composition, the photocurable composition comprising (A) a polymerizable group-containing photopolymerization initiator and (B) a polymerizable compound.

The photocurable coating composition of the present invention preferably has substantially no absorption in the visible region. ‘Having substantially no absorption in the visible region’ means either having no absorption in a visible region of 400 to 700 nm or having only a level of absorption in the visible region that does not cause any problem as a photocurable coating composition. Specifically, a 5 μm optical path length transmittance of the coating composition in a wavelength region of 400 to 700 nm is at least 70%, and preferably at least 80%.

The photocurable coating composition of the present invention may suitably be used as one for an overprint, and may particularly suitably be used as one for an overprint for an electrophotographically printed material.

When the photocurable coating composition of the present invention is used for forming an overprint layer on an electrophotographically printed material having an image area with a thickness of a toner, an overprint with excellent non-tackiness and surface smoothness and having luster and gloss can be obtained, and an impression that it is visually close to a conventional silver halide photographic print can be given.

When a fuser oil layer is present on an image surface in a toner-based image such as in an electrophotographic method, since the surface of a printed material is hydrophobic and the surface energy is low, it is currently difficult to obtain a photocurable composition that satisfies all of curability, surface smoothness, strength, storage stability, etc.

Furthermore, when the photocurable coating composition of the present invention is used for a toner image having a layer of fuser oil on the image surface, an image-printed material that has excellent non-tackiness and surface smoothness, has luster and gloss, has little distortion, and is highly flexible can be given, and an overprint that is visually close to a silver halide photographic print can be obtained.

Furthermore, in particular, when an overprint coating is applied onto toner-based image information to thus serve as an alternative product to a silver halide photographic print, since a consumer handles it directly, odor and product safety are counted as important product qualities.

As a cause of the occurrence of an odor, there can be cited a decomposition product of a polymerization initiator that is not taken into a resin in a cured coating due to lack of copolymerizability.

The photocurable coating composition of the present invention can suppress odor in an overprint by the use of (A) a polymerizable group-containing photopolymerization initiator.

### (A) Polymerizable Group-Containing Photopolymerization Initiator

The photocurable coating composition of the present invention comprises (A) a polymerizable group-containing photopolymerization initiator as an essential component.

The polymerizable group-containing photopolymerization initiator (A) referred to in the present invention denotes a compound that has the conventionally known function of a polymerization initiator in generating a polymerization-initiating species such as a radical or a cation by optical energy, and starting and promoting polymerization of a polymerizable compound and, furthermore, that contains a polymerizable group in the molecule.

As a parent skeleton compound for the polymerizable group-containing photopolymerization initiator (A), that is, a polymerization initiator into which a polymerizable group is introduced, a known photopolymerization initiator, a compound having a bond with a small bond dissociation energy, etc. may be selected and used.

As the polymerizable group of the polymerizable group-containing photopolymerization initiator (A), a cationically polymerizable group, an anionically polymerizable group, a radically polymerizable group, etc. can be cited.

As the polymerizable group-containing photopolymerization initiator (A), an ethylenically unsaturated bond- and/or cyclic ether group-containing compound is preferable.

Furthermore, in the present invention, when a radically polymerizable compound is used as a polymerizable compound, it is preferable to use a radical photopolymerization initiator, and when a cationically polymerizable compound is used, it is preferable to use a cationic photopolymerization initiator.

The radically polymerizable group of the radically polymerizable group-containing photopolymerization initiator that can be used in the present invention is preferably a group having an ethylenically unsaturated double bond, more preferably a group having a terminal ethylenically unsaturated double bond, and yet more preferably a group selected from the group consisting of a (meth)acryloxy group, an allyl group, a vinyl group, and a vinyloxy group.

‘(Meth)acrylic’ denotes both ‘acrylic’ and ‘methacrylic’.

The cationically polymerizable group of the cationically polymerizable group-containing photopolymerization initiator that can be used in the present invention is preferably an ethylenically unsaturated bond-containing group and/or a cyclic ether group, more preferably a vinyloxy group and/or a cyclic ether group, yet more preferably a group selected from the group consisting of a vinyloxy group, an epoxy group, and an oxetanyl group, and particularly preferably an epoxy group and/or an oxetanyl group.

In the present invention, the number of polymerizable groups of the polymerizable group-containing photopolymerization initiator (A) is preferably 1 to 5 per molecule or per ion, more preferably 1 to 3, and yet more preferably 1 or 2. It is preferable for it to be in the above-mentioned range since a balance between surface smoothness and the suppression of tackiness and odor can be achieved.

In addition, when the polymerizable group-containing photopolymerization initiator (A) has two or more polymerizable groups, the polymerizable groups may be identical to or different from each other.

Furthermore, the polymerizable group-containing photopolymerization initiator (A) is preferably a compound that is selected from the group consisting of an onium salt compound, a borate salt compound, an imide structure-containing compound, a triazine structure-containing compound, an azo compound, a peroxide, and a lophine dimer structure-containing compound and that has a polymerizable group, is more preferably a compound that is selected from the group consisting of an onium salt compound, an imide structure-containing compound, and a triazine structure-containing compound and that has a polymerizable group and, from the viewpoint of non-tackiness (suppression of surface tackiness) and absorption in the visible light region, is yet more preferably a polymerizable group-containing onium salt compound.

As a preferred onium salt compound, a sulfonium salt compound, an iodonium salt compound, a diazonium salt compound, an azinium salt compound, an ammonium salt compound, a pyridinium salt compound, etc. can be cited. From the viewpoint of stability and non-tackiness (suppression of surface tackiness), as an onium salt compound, a sulfonium salt compound and/or an iodonium salt compound are more preferable.

The polymerizable group of these onium salt compounds may be introduced into either a cationic parent nucleus or a counteranion of the onium salt.

Such an onium salt compound is conventionally known as a high sensitivity polymerization initiator. When a polymerizable group is introduced into a cationic parent nucleus of an onium salt compound, due to the polymerizable group being polymerized a decomposition by-product does not volatilize but instead is incorporated into a cured coating, and it is therefore possible to suppress the occurrence of odor due to a by-product of the photoinitiator, which is preferable.

In the present invention, as an onium salt compound that can form the polymerizable group-containing photopolymerization initiator (A) by having a polymerizable group introduced thereinto, there can be cited as preferred examples a diazonium salt compound, an iodonium salt compound, a sulfonium salt compound, an ammonium salt compound, and a pyridinium salt compound.

Specific preferred examples of a parent skeleton compound for the polymerizable group-containing photopolymerization initiator (A) include onium salt compounds represented by Formulae (III) to (V) below.

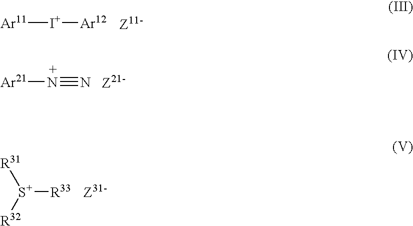

In Formula (III), Ar¹¹ and Ar¹² independently denote an optionally substituted aryl group having no greater than 20 carbon atoms. As a preferred substituent when this aryl group has a substituent, a halogen atom, a nitro group, an alkyl group having no greater than 12 carbon atoms, an alkoxy group having no greater than 12 carbon atoms, and an aryloxy group having no greater than 12 carbon atoms can be cited. Z¹¹⁻ denotes a counterion selected from the group consisting of a halide ion, a perchlorate ion, a tetrafluoroborate ion, a hexafluorophosphate ion, a hexafluoroarsenate ion, a sulfonate ion, and a carboxylate ion, and from the viewpoint of sensitivity and stability a perchlorate ion, a hexafluorophosphate ion, a carboxylate ion, or a sulfonate ion is preferable. Examples of the sulfonate ion include a trifluoromethanesulfonate ion and a toluenesulfonate ion (TsO⁻).

In Formula (IV), Ar²¹ denotes an optionally substituted aryl group having no greater than 20 carbon atoms. As a preferred substituent, there can be cited a halogen atom, a nitro group, an alkyl group having no greater than 12 carbon atoms, an alkoxy group having no greater than 12 carbon atoms, an aryloxy group having no greater than 12 carbon atoms, an alkylamino group having no greater than 12 carbon atoms, a dialkylamino group having no greater than 12 carbon atoms, an arylamino group having no greater than 12 carbon atoms, and a diarylamino group having no greater than 12 carbon atoms. Z²¹- denotes a counterion having the same meaning as that of the above-mentioned Z¹¹⁻, and a preferred range is also the same.

In Formula (V), R³¹, R³² and R³³ may be identical to or different from each other and denote an optionally substituted hydrocarbon group having no greater than 20 carbon atoms. As a preferred substituent, there can be cited a halogen atom, a nitro group, an alkyl group having no greater than 12 carbon atoms, an aryl group having no greater than 12 carbon atoms, an alkoxy group having no greater than 12 carbon atoms, and an aryloxy group having no greater than 12 carbon atoms. As a preferred hydrocarbon group, there can be cited an alkyl group having no greater than 12 carbon atoms and an aryl group having no greater than 12 carbon atoms. Z³¹⁻ denotes a counterion having the same meaning as that of the above-mentioned Z¹¹⁻, and a preferred range is also the same.

Furthermore, a sulfonium salt, an iodonium salt, etc. having a carboxylate (carboxylate ion) as a counteranion described in JP-A-2001-343742 can also be cited as preferred parent nucleus compounds of the photopolymerization initiator.

In the present invention, these onium salt compounds function not only as an acid generator, that is, a cationic polymerization initiator, but also as a radical polymerization initiator.

In the coating composition of the present invention, it is preferable to use in combination a radically polymerizable compound and an ethylenically unsaturated bond-containing onium salt compound.

In particular, from the viewpoint of safety an iodonium salt compound or a sulfonium salt compound is preferable.

In the present invention, as the polymerizable group-containing photopolymerization initiator (A), it is preferable to use any compound among the above parent nucleus compounds into which at least one of the above polymerizable groups has been introduced, and it is more preferable to use an onium salt in which a polymerizable group has been introduced into an onium ion.

A method for synthesizing the onium salt compound described above is not particularly limited, and synthesis may be carried out by a known method. Furthermore, synthesis may be carried out easily in the same manner as in a method for preparing an iodonium salt or a sulfonium salt described in JP-A-4-230645 or a method described in Journal of Organic Chemistry, 1980, 45,1542-1543.

Moreover, as the onium salt compound, from the viewpoint of sensitivity and stability, a diazonium salt, an iodonium salt, and a sulfonium salt can be cited as preferred examples, and an iodonium salt compound and a sulfonium salt compound, represented by Formula (VI) or Formula (VIl) below, into which a polymerizable group has been introduced can be cited as particularly preferred examples.

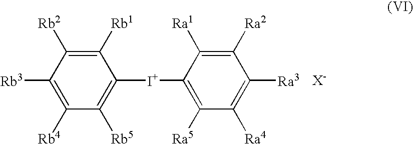

In Formula (VI) above, Ra¹ to Ra⁵ and Rb¹ to Rb⁵ independently denote a hydrogen atom, an alkyl group having no greater than 20 carbon atoms, an aryl group having no greater than 20 carbon atoms, an alkoxy group having no greater than 20 carbon atoms, an arylalkoxy group having no greater than 20 carbon atoms, an alkylthio group having no greater than 20 carbon atoms, or an arylthio group having no greater than 20 carbon atoms, the groups being optionally substituted with a group selected from the group consisting of a halogen atom, a carbonyloxy group, a carbonyl group, an amide group, an alkenyl group, and an alkynyl group, or a group that is formed by combining the above groups and has no greater than 20 carbon atoms in total. In addition, at least one of Ra¹ to Ra⁵ and Rb¹ to Rb⁵ is a polymerizable group or a polymerizable group-containing group, and the polymerizable group is preferably a (meth)acryloxy group-, styryl group-, vinyl group-, or allyl group-containing group. As a preferred substitution position, from the viewpoint of synthesis it is preferable to have a substituent or a polymerizable group on Ra³ and Rb³. As a polymerizable group, from the viewpoint of sensitivity a (meth)acryloxy group is more preferable. X⁻ denotes a monovalent anion, and is preferably a perchlorate ion, a hexafluorophosphate ion, a borate ion, a carboxylate ion, or a sulfonate ion.

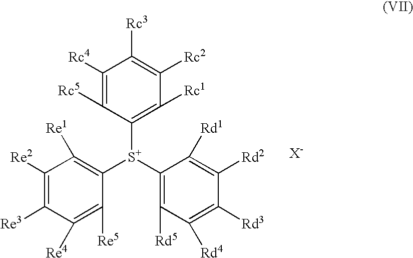

In Formula (VIl) above, Rc¹ to Rc⁵, Rd¹ to Rd⁵, and Re¹ to Re⁵ independently denote a hydrogen atom, an alkyl group having no greater than 20 carbon atoms, an aryl group having no greater than 20 carbon atoms, an alkoxy group having no greater than 20 carbon atoms, an arylalkoxy group having no greater than 20 carbon atoms, an alkylthio group having no greater than 20 carbon atoms, or an arylthio group having no greater than 20 carbon atoms, the groups being optionally substituted with a group selected from the group consisting of a halogen atom, a carbonyloxy group, a carbonyl group, an amide group, an alkenyl group, and an alkynyl group. In addition, at least one of Rc¹ to Rc⁵, Rd¹ to Rd⁵, and Re¹ to Re⁵ is a polymerizable group or a polymerizable group-containing group, and preferably a (meth)acryloxy group-, (meth)acrylamide group-, vinyl group-, or allyl group-containing group. As a preferred substitution position, from the viewpoint of synthesis it is preferable to have a substituent or a polymerizable group on Rc³, Rd³ and Re³. As the polymerizable group, from the viewpoint of sensitivity, a (meth)acryloxy group is more preferable. X⁻ denotes a monovalent anion, and is preferably a perchlorate ion, a hexafluorophosphate ion, a carboxylate ion, or a sulfonate ion.

Furthermore, in Formula (VII), a sulfonium salt compound in which any one of the phenyl groups bonded to the sulfur atom is replaced by an alkyl group having no greater than 10 carbon atoms may also be preferably used.

Preferred examples of the borate salt compound include compounds represented by Formula (VIII) below.

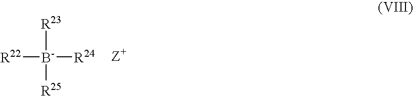

In Formula (VIII) above, R²², R²³, R²⁴, and R²⁵ may be identical to or different from each other, and each denotes a substituted or unsubstituted alkyl group having no greater than 20 carbon atoms, a substituted or unsubstituted aryl group having no greater than 20 carbon atoms, a substituted or unsubstituted alkenyl group having no greater than 20 carbon atoms, a substituted or unsubstituted alkynyl group having no greater than 20 carbon atoms, an acryloxy group-containing group having no greater than 20 carbon atoms, a methacryloxy group-containing group having no greater than 20 carbon atoms, a vinyloxy group-containing group having no greater than 20 carbon atoms, an epoxy group-containing group having no greater than 20 carbon atoms, an oxetanyl group-containing group having no greater than 20 carbon atoms, or a substituted or unsubstituted 3- to 20-membered heterocyclic group, and two or more of the R²², R²³, R²⁴, and R²⁵ groups may be bonded to form a ring structure. In addition, at least one of R²², R²³, R²⁴, and R²⁵ is a group selected from the group consisting of a substituted or unsubstituted alkenyl group having no greater than 20 carbon atoms, a substituted or unsubstituted alkynyl group having no greater than 20 carbon atoms, an acryloxy group-containing group having no greater than 30 carbon atoms, a methacryloxy group-containing group having no greater than 30 carbon atoms, a vinyloxy group-containing group having no greater than 30 carbon atoms, an epoxy group-containing group having no greater than 30 carbon atoms, and an oxetanyl group-containing group having no greater than 30 carbon atoms. Z⁺ denotes an alkali metal cation or a quaternary ammonium cation.

Furthermore, among the four groups bonded to the boron atom in Formula (VIII), at least one is preferably a group having no greater than 20 carbon atoms and being bonded via an aliphatic carbon atom.

As the alkyl group denoted by R²² to R²⁵ above, straight-chain, branched, and cyclic groups are included, and one having 1 to 18 carbon atoms is preferable. Specific examples thereof include methyl, ethyl, propyl, isopropyl, butyl, pentyl, hexyl, octyl, stearyl, cyclobutyl, cyclopentyl, and cyclohexyl. As a substituted alkyl group, alkyl groups as above that have as a substituent a halogen atom (e.g. —Cl, —Br, etc.), a cyano group, a nitro group, an aryl group (preferably a phenyl group), a hydroxy group, —NR²⁶R²⁷ (R²⁶ and R²⁷ independently denote a hydrogen atom, an alkyl group having 1 to 14 carbon atoms, or an aryl group), —COOR²⁸ (R²⁸ denotes a hydrogen atom, an alkyl group having 1 to 14 carbon atoms, or an aryl group), —OCOR²⁹, or —OR³⁰ (here, R²⁹ and R³⁰ denote an alkyl group having 1 to 14 carbon atoms or an aryl group) are included.

As the aryl group denoted by R²² to R²⁵ above, mono- to tri-cyclic aryl groups such as a phenyl group and a naphthyl group are included, and as the substituted aryl group, aryl groups as above that have a substituent described above for the substituted alkyl group or an alkyl group having 1 to 14 carbon atoms are included.

As the alkenyl group denoted by R²² to R²⁵ above, straight-chain, branched, or cyclic groups having 2 to 18 carbon atoms are included, and as a substituent of the substituted alkenyl group, substituents described above for the substituted alkyl group are included.

As the alkynyl group denoted by R²² to R²⁵ above, straight-chain or branched groups having 2 to 28 carbon atoms are included, and as a substituent of the substituted alkynyl group, substituents described above for the substituted alkyl group are included.

As the acryloxy group-containing group, methacryloxy group-containing group, vinyloxy group-containing group, epoxy group-containing group, or oxetanyl group-containing group denoted by R²² to R²⁵ above, it is not particularly limited as long as it is a group having at least one acryloxy group, methacryloxy group, vinyloxy group, epoxy group, or oxetanyl group, but a group having 3 to 30 carbon atoms and being formed from hydrogen, carbon, and oxygen atoms is preferable.

Furthermore, as the heterocyclic group denoted by R²² to R²⁵ above, a 5- or higher-membered ring containing at least one of N, S, and O is preferable; a 5 to 7-membered heterocyclic group is more preferable, and this heterocyclic group may include a condensed ring. It may further have as a substituent a substituent described above for the substituted aryl group.

Preferred examples of the peroxide include an epoxy group- and/or oxetanyl group-containing percarboxylic acid.

As the epoxy group- and/or oxetanyl group-containing percarboxylic acid, for example, a compound represented by Formula (IX) below is preferable.

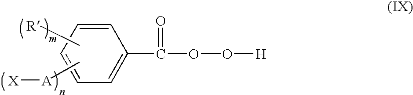

In Formula (IX), X denotes an epoxy group or an oxetanyl group, A denotes a single bond or a divalent linking group, R′ denotes a substituent, n denotes an integer of 1 to 5, and m denotes an integer of 0 to 4.

When there are two or more Xs in Formula (IX), they may be identical to or different from each other.

A in Formula (IX) is preferably a single bond, an alkylene group having no greater than 10 carbon atoms, or a group in which two or more of an alkylene group having no greater than 10 carbon atoms and an ether bond are combined. When there are two or more As in Formula (IX), they may be identical to or different from each other.

R′ in Formula (IX) is preferably an alkyl group having no greater than 20 carbon atoms, an alkoxy group having no greater than 20 carbon atoms, or a halogen atom. Furthermore, when there are two or more R's in Formula (IX), they may be identical to or different from each other.

n in Formula (IX) is preferably 1 or 2, and more preferably 1.

Preferred examples of the lophine dimer include a compound in which a polymerizable group-containing group is bonded to at least one aryl group of a hexaarylbiimidazole structure.

Preferred examples of the polymerizable group-containing group include an ethylenically unsaturated bond- or cyclic ether group-containing group, more preferred examples thereof include, a group having no greater than 30 carbon atoms and containing a group having at least one of an acryloxy group, methacryloxy group, a vinyloxy group, an epoxy group, and an oxetanyl group, and yet more preferred examples thereof include a group formed from hydrogen, carbon, and oxygen atoms, having 3 to 30 carbon atoms, and containing at least one acryloxy group, methacryloxy group, vinyloxy group, epoxy group, or oxetanyl group.

As an example of the triazine compound, a compound in which one polymerizable group-containing group is bonded to a triazine ring containing two trichloromethyl groups can be cited as a preferred example.

Preferred examples of the polymerizable group-containing group include an ethylenically unsaturated bond- or cyclic ether group-containing group, more preferred examples thereof include a group containing a group having at least one acryloxy group, methacryloxy group, vinyloxy group, epoxy group, or oxetanyl group, and yet more preferred examples thereof include a group formed from hydrogen, carbon, and oxygen atoms, having 3 to 30 carbon atoms, and containing at least one acryloxy group, methacryloxy group, vinyloxy group, epoxy group, or oxetanyl group.

Furthermore, preferred examples of the triazine compound include a compound described in German Patent No. 3337024.

Specific examples of the triazine compound are listed below. In some chemical formulae in the present invention, a hydrocarbon chain is represented by a simplified structural formula in which symbols for carbon (C) and hydrogen (H) are omitted.

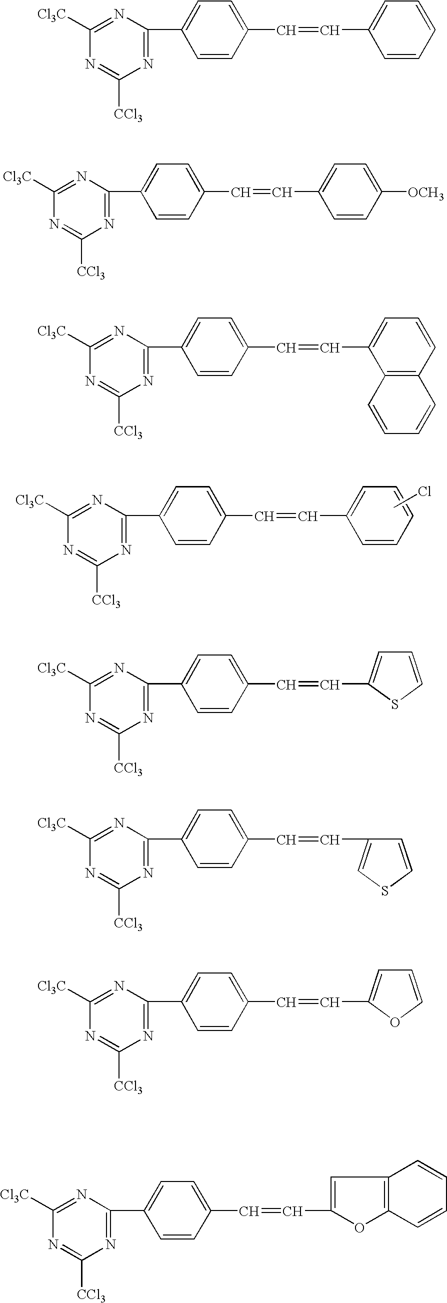

Furthermore, as a preferred example of the triazine compound, a compound described in JP-A-62-58241 can also be cited.

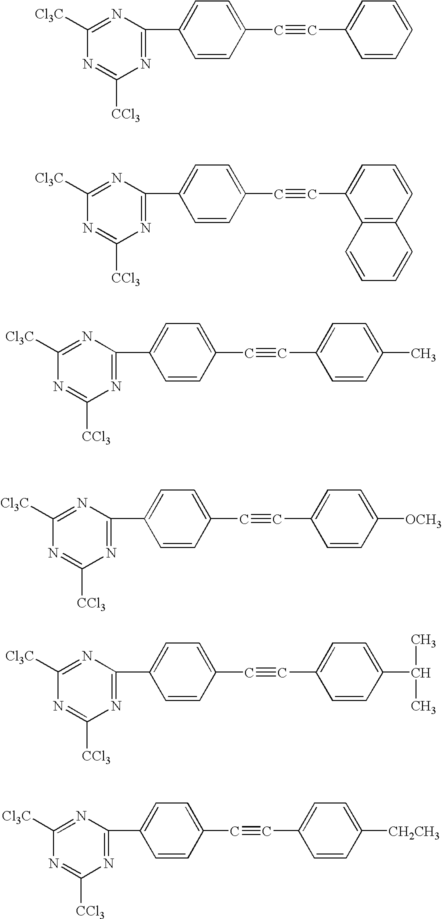

Preferred examples of the azo compound include a compound represented by Formula (X) below.

X¹—N═N—X² (X)

In Formula (X), X¹ and X² independently denote a polymerizable group-containing group.

Furthermore, the polymerizable group-containing group is preferably an ethylenically unsaturated bond- or cyclic ether group-containing group, more preferably a group containing a group having at least one acryloxy group, methacryloxy group, vinyloxy group, epoxy group, or oxetanyl group, and yet more preferably a group formed from hydrogen, carbon, and oxygen atoms, having 3 to 30 carbon atoms, and containing at least one acryloxy group, methacryloxy group, vinyloxy group, epoxy group, or oxetanyl group.

Furthermore, the compound represented by Formula (X) is preferably one that has —C(CH₃)₂—N═N—C(CH₃)₂— as a structure.

Preferred examples of the imide structure-containing compound include compounds represented by Formula (XI) to Formula (XIV) below.

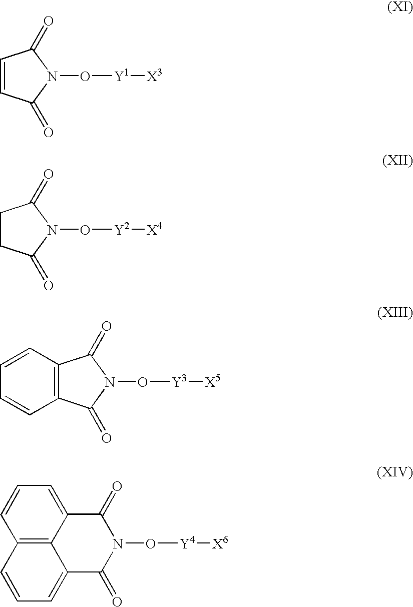

X³ in Formula (XI) denotes a monovalent organic group or a polymerizable group-containing group.

In Formula (XII) to Formula (XIV), X⁴, X⁵, and X⁶ denote a polymerizable group-containing group.

The polymerizable group-containing group denoted by X³ to X⁶ is preferably an ethylenically unsaturated bond- or cyclic ether group-containing group, more preferably an acryloxy group, a methacryloxy group, or a group containing a group having at least one vinyloxy group, epoxy group, or oxetanyl group, and yet more preferably an acryloxy group, a methacryloxy group, or a group formed from hydrogen, carbon, and oxygen atoms, having 3 to 30 carbon atoms, and containing at least one vinyloxy group, epoxy group, or oxetanyl group.

The monovalent organic group denoted by X³ is not particularly limited, but is preferably an alkyl group having 1 to 30 carbon atoms, an aryl group having 6 to 30 carbon atoms, or an aralkyl group having 7 to 30 carbon atoms.

In Formula (XI) to Formula (XIV), Y¹, Y², Y³ and Y⁴ denote a carbonyl group or —SO₂—.

Specific preferred examples of the polymerizable group-containing photopolymerization initiator (A) are listed below, but the present invention is not limited thereby. In the polymerizable group-containing photopolymerization initiator (A) below, [compound example (I-1) to compound example (I-10)] are iodonium salt compounds, [compound example (S-1) to compound example (S-11)] are sulfonium salt compounds, and [compound example (N-1) to compound example (N-18)] are diazonium salt compounds, imide structure-containing compounds, triazine structure-containing compounds, ammonium salt compounds, pyridinium salt compounds, lophine dimer structure-containing compounds, and borate salt compounds.

Among the specific examples below, compounds represented by (I-1) to (I-10), (S-1) to (S-1 1), and, (N-1) to (N-15) are particularly preferable.

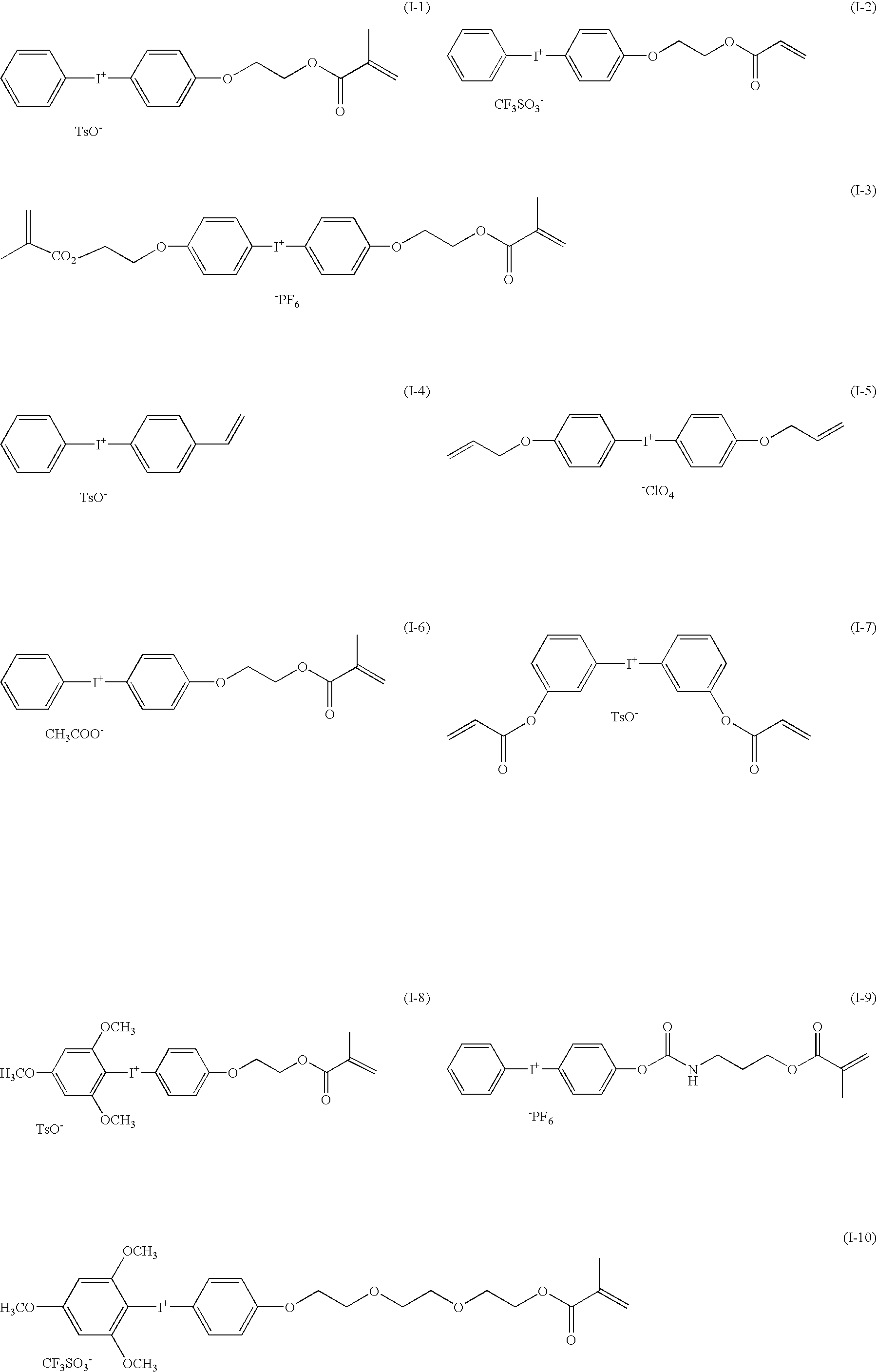

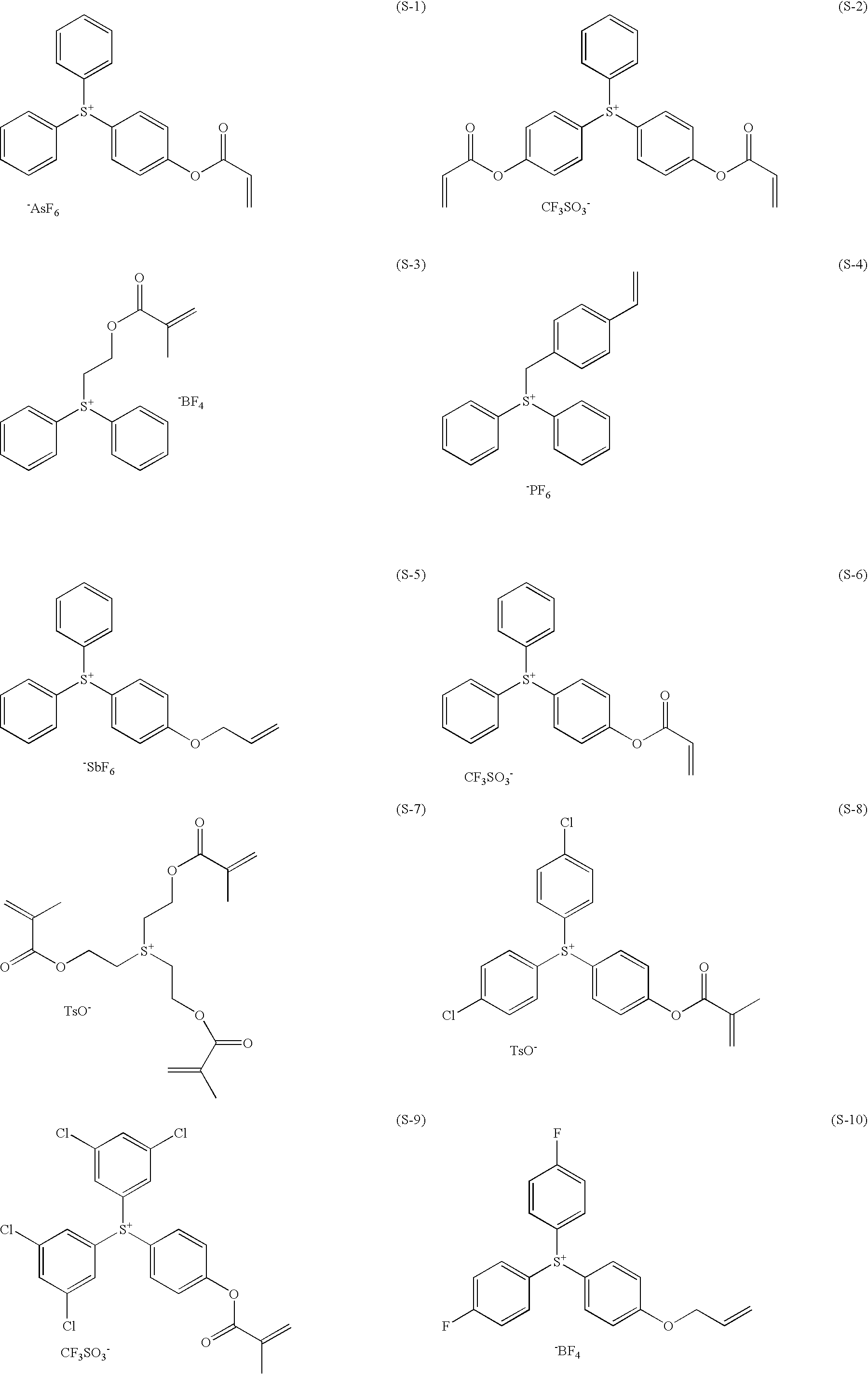

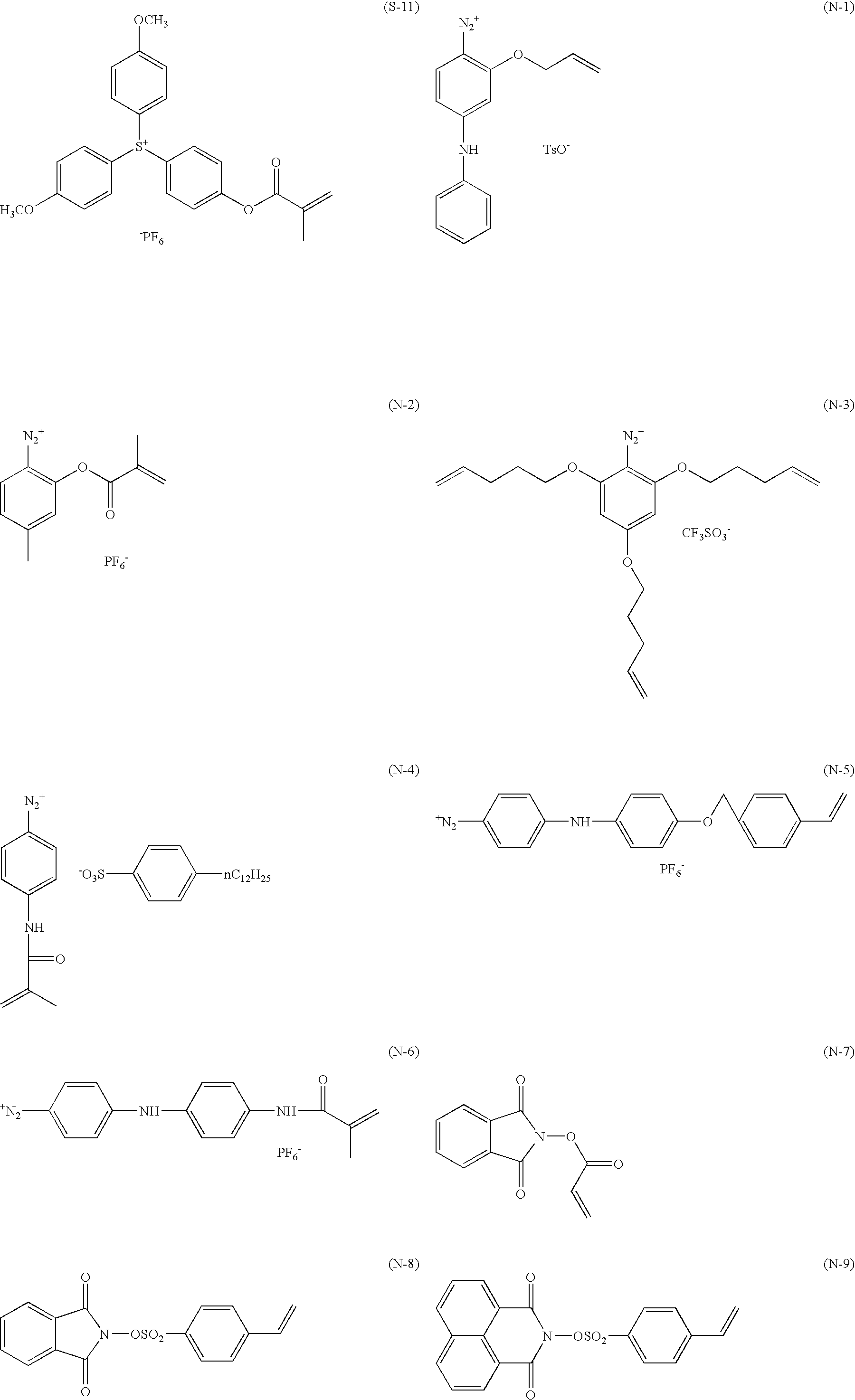

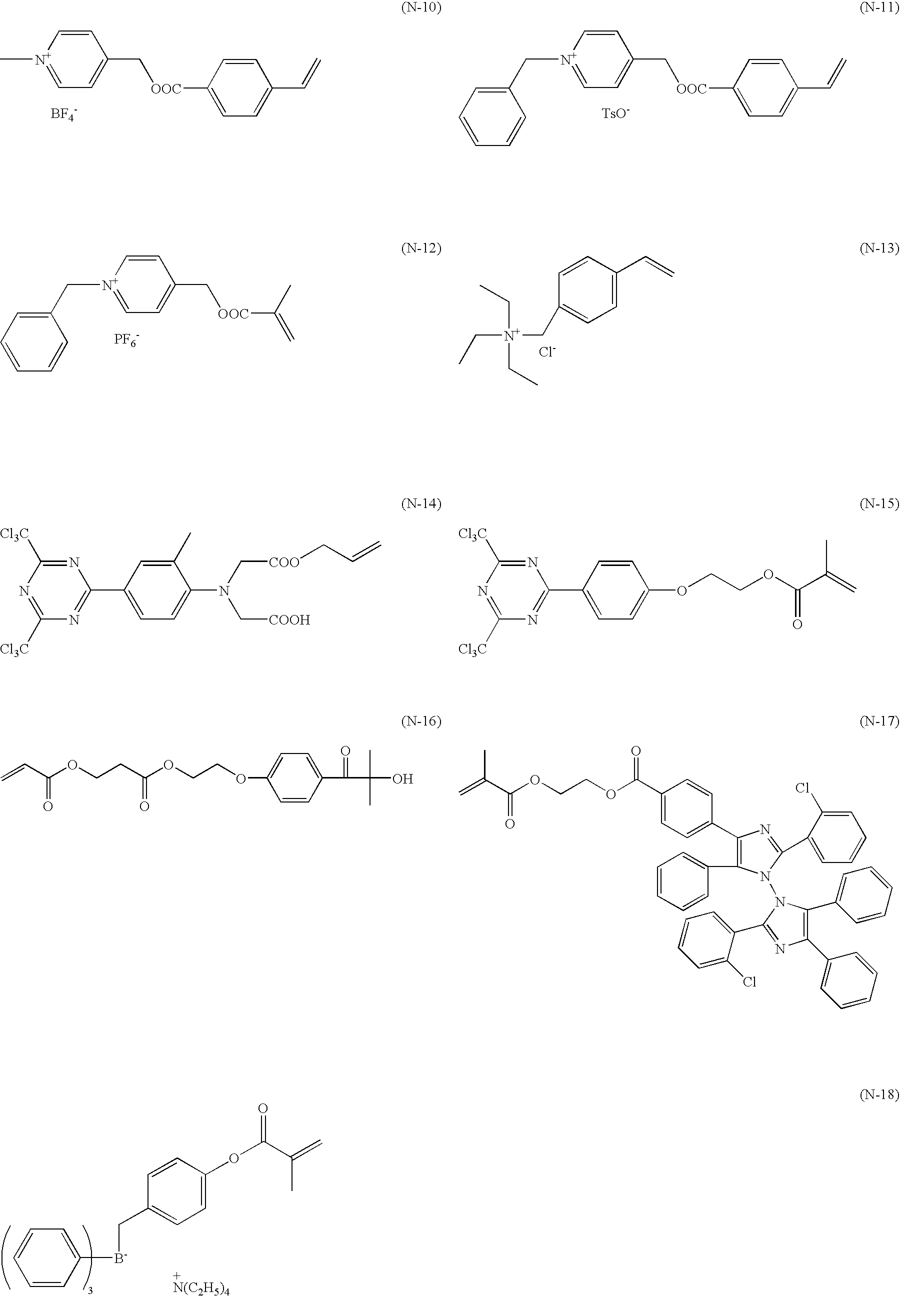

Furthermore, as specific examples of the polymerizable group-containing photopolymerization initiator (A), with regard to (I-1) to (I-10), (S-1) to (S-1 1), and (N-1) to (N-18), a compound in which the structure represented by (Et-1) or (Et-2) below is replaced by the structure represented by (Re-1) or (Re-2) below, a compound in which the structure represented by (Et-3) below is replaced by a structure represented by (Re-3) or (Re-4) below, a compound in which the structure represented by (Et-4) below is replaced by a structure represented by (Re-1) or (Re-2) below, a compound in which the structure represented by (Et-5) below is replaced by a structure represented by (Re-1), (Re-2), or (Re-5) below, and a compound in which the structure represented by (Et-6) below is replaced by the structure represented by Formula (Re-6) can be cited as preferred examples. The portion with a wavy line in the formulae below is the portion via which it is bonded to another structure.

Moreover, a compound in which, with regard to a compound represented by (I-1) to (I-10), (S-1) to (S-11), and (N-1) to (N-15), the structure represented by (Et-1) to (Et-6) is replaced by a structure represented by (Re-1) to (Re-6) is particularly preferable.

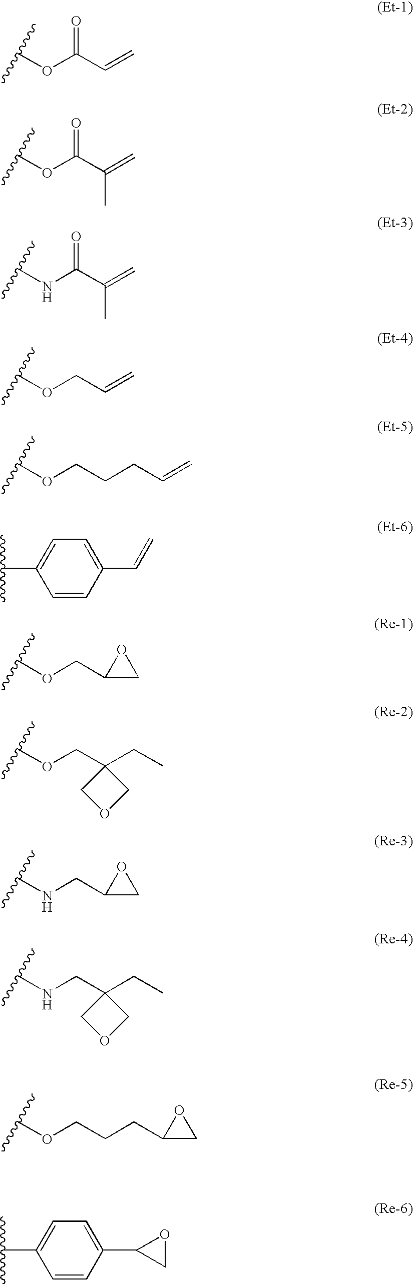

With regard to the polymerizable group-containing photopolymerization initiator (A), only one type may be used or two or more types may be used in combination.

The amount of polymerizable group-containing photopolymerization initiator (A) added is preferably 1 to 45 wt % relative to the total weight of the photocurable coating composition, more preferably 3 to 40 wt %, and yet more preferably 5 to 35 wt %. When the amount added is at least 1 wt %, the sensitivity and non-tackiness are excellent. Furthermore, when it is no greater than 45 wt %, the viscosity of the coating composition is appropriate and the surface smoothness is excellent.

In addition, the coating composition of the present invention may comprise in addition to the polymerizable group-containing photopolymerization initiator (A) a known photopolymerization initiator that does not have a polymerizable group in the molecule as long as the effects of the present invention are not impaired. As such a polymerization initiator, various types of polymerization initiators including an onium salt compound that is exemplified as a compound that is a parent skeleton compound for introducing an unsaturated group thereinto, described above for the polymerizable group-containing photopolymerization initiator, may be used.

The amount added of the known polymerization initiator that can be used in combination is preferably 0 to no greater than 30 wt % of the total amount of initiators in the coating composition including the polymerizable group-containing photopolymerization initiator (A), more preferably 0 to no greater than 15 wt %, and particularly preferably 0 wt %, that is, the initiator being only the polymerizable group-containing photopolymerization initiator (A).

Furthermore, when a sensitizer, which is described later, is used, the ratio by weight of the polymerizable group-containing photopolymerization initiator (A) relative to the sensitizer is preferably polymerizable group-containing photopolymerization initiator (A): sensitizer =200:1 to 1:200, more preferably 50:1 to 1:50, and yet more preferably 20:1 to 1:5.

### (B) Polymerizable Compound

The coating composition of the present invention comprises (B) a polymerizable compound.

As the polymerizable compound, a radically polymerizable compound may be used or a cationically polymerizable compound may be used.

### Radically Polymerizable Compound

In the present invention, a radically polymerizable compound is preferably a compound having at least one ethylenically unsaturated bond.

The radically polymerizable compound may be any compound as long as it has at least one ethylenically unsaturated bond, and a monomer, an oligomer, a polymer, etc. are included.

With regard to the radically polymerizable compound, one type thereof may be used or, in order to improve intended properties, two or more types may be used in combination at any ratio. From the viewpoint of controlling reactivity, physical properties, etc., it is preferable to use two or more types of radically polymerizable compounds in combination.

Examples of the radically polymerizable compound include unsaturated carboxylic acids such as acrylic acid, methacrylic acid, itaconic acid, crotonic acid, isocrotonic acid, and maleic acid, and salts thereof, anhydrides having an ethylenically unsaturated bond, acrylonitrile, styrene, various types of unsaturated polyesters, unsaturated polyethers, unsaturated polyamides, and unsaturated urethanes.

Specific examples thereof include acrylic acid derivatives such as methyl acrylate, ethyl acrylate, n-butyl acrylate, 2-ethylhexyl acrylate, 2-hydroxyethyl acrylate, butoxyethyl acrylate, carbitol acrylate, cyclohexyl acrylate, tetrahydrofurfuryl acrylate, benzyl acrylate, bis(4-acryloxypolyethoxyphenyl)propane, neopentyl glycol diacrylate, 1,6-hexanediol diacrylate, ethylene glycol diacrylate, diethylene glycol diacrylate, triethylene glycol diacrylate, tetraethylene glycol diacrylate, polyethylene glycol diacrylate, polypropylene glycol diacrylate, pentaerythritol triacrylate, pentaerythritol tetraacrylate, dipentaerythritol tetraacrylate, trimethylolpropane triacrylate, tetramethylolmethane tetraacrylate, oligoester acrylate, N-methylolacrylamide, diacetoneacrylamide, and epoxyacrylate, methacrylic derivatives such as methyl methacrylate, ethyl methacrylate, n-butyl methacrylate, 2-ethylhexyl methacrylate, lauryl methacrylate, allyl methacrylate, glycidyl methacrylate, benzyl methacrylate, dimethylaminomethyl methacrylate, 1,6-hexanediol dimethacrylate, ethylene glycol dimethacrylate, triethylene glycol dimethacrylate, polyethylene glycol dimethacrylate, polypropylene glycol dimethacrylate, trimethylolethane trimethacrylate, trimethylolpropane trimethacrylate, and 2,2-bis(4-methacryloxypolyethoxyphenyl)propane, N-vinyl compounds such as N-vinylpyrrolidone and N-vinylcaprolactam, allyl compound derivatives such as allyl glycidyl ether, diallyl phthalate, and triallyl trimellitate and, more specifically, radically polymerizable or crosslinking monomers, oligomers, and polymers that are commercial products or are industrially known, such as those described in ‘Kakyozai Handobukku’ (Crosslinking Agent Handbook), Ed. S. Yamashita (Taiseisha, 1981); ‘UV-EB Koka Handobukku’ (UV-EB Curing Handbook) (Starting Materials) Ed. K. Kato (Kobunshi Kankoukai, 1985); ‘UV-EB Koka Gijutsu no Oyo to Shijyo’ (Application and Market of UV-EB Curing Technology), p. 79, Ed. Rad Tech (CMC, 1989); and E. Takiyama ‘Poriesuteru Jushi Handobukku’ (Polyester Resin Handbook), (The Nikkan Kogyo Shimbun Ltd., 1988) may be used.

Furthermore, as the radically polymerizable compound, photocuring polymerizable compound materials used in photopolymerizable compositions described in, for example, JP-A-7-159983, JP-B-7-31399, JP-A-8-224982, JP-A-10-863, JP-A-9-134011, etc. are known, and they may be used in the coating composition of the present invention.

Moreover, as the radically polymerizable compound, a vinyl ether compound is also preferably used. Examples of vinyl ether compounds that can suitably be used include di- or tri-vinyl ether compounds such as ethylene glycol divinyl ether, diethylene glycol divinyl ether, triethylene glycol divinyl ether, propylene glycol divinyl ether, dipropylene glycol divinyl ether, butanediol divinyl ether, hexanediol divinyl ether, cyclohexanedimethanol divinyl ether, and trimethylolpropane trivinyl ether, and monovinyl ether compounds such as ethyl vinyl ether, n-butyl vinyl ether, isobutyl vinyl ether, octadecyl vinyl ether, cyclohexyl vinyl ether, hydroxybutyl vinyl ether, 2-ethylhexyl vinyl ether, cyclohexanedimethanol monovinyl ether, n-propyl vinyl ether, isopropyl vinyl ether, isopropenyl vinyl ether, dodecyl vinyl ether, diethylene glycol monovinyl ether, ethylene glycol monovinyl ether, triethylene glycol monovinyl ether, hydroxyethyl monovinyl ether, and hydroxynonyl monovinyl ether.

Among these vinyl ether compounds, divinyl ether compounds and trivinyl ether compounds are preferable from the viewpoint of curability, adhesion, and surface hardness, and divinyl ether compounds are particularly preferable. With regard to the vinyl ether compound, one type thereof may be used on its own or two or more types may be used in an appropriate combination.

As other polymerizable compounds that can be used in the present invention, (meth)acrylic acid esters (hereinafter, also called ‘(meth)acrylate compounds’) such as (meth)acrylic-based monomers or prepolymers, epoxy-based monomers or prepolymers, or urethane-based monomers or prepolymers are preferably used. More preferred examples thereof are as follows. ‘(Meth)acrylic’ denotes both ‘acrylic’ and ‘methacrylic’, and ‘(meth)acrylate’ denotes both ‘acrylate’ and ‘methacrylate’.

That is, there can be cited 2-ethylhexyldiglycol (meth)acrylate, 2-hydroxy-3-phenoxypropyl (meth)acrylate, 2-hydroxybutyl (meth)acrylate, hydroxypivalic acid neopentyl glycol di(meth)acrylate, 2-(meth)acryloyloxyethylphthalic acid, methoxy polyethylene glycol (meth)acrylate, tetramethylolmethane tri(meth)acrylate, 2-)meth)acryloyloxyethyl-2-hydroxyethylphthalic acid, dimethyloltricyclodecane di(meth)acrylate, ethoxylated phenyl (meth)acrylate, 2-(meth)acryloyloxyethylsuccinic acid, nonylphenol ethylene oxide (EO) adduct (meth)acrylate, modified glycerol tri(meth)acrylate, bisphenol A diglycidyl ether (meth)acrylic acid adduct, modified bisphenol A di(meth)acrylate, phenoxypolyethylene glycol (meth)acrylate, 2-(meth)acryloyloxyethylhexahydrophthalic acid, bisphenol A propylene oxide (PO) adduct di(meth)acrylate, bisphenol A EO adduct di(meth)acrylate, dipentaerythritol hexa(meth)acrylate, pentaerythritol tri(meth)acrylate tolylenediisocyanate urethane prepolymer, lactone-modified flexible (meth)acrylate, butoxyethyl (meth)acrylate, propylene glycol diglycidyl ether (meth)acrylic acid adduct, pentaerythritol tri(meth)acrylate hexamethylenediisocyanate urethane prepolymer, 2-hydroxyethyl (meth)acrylate, methoxydipropylene glycol (meth)acrylate, ditrimethylolpropane tetra(meth)acrylate, pentaerythritol tri(meth)acrylate hexamethylenediisocyanate urethane prepolymer, stearyl (meth)acrylate, isoamyl (meth)acrylate, isomyristyl (meth)acrylate, isostearyl (meth)acrylate, lactone-modified (meth)acrylate etc.

The monomers listed above have high reactivity, low viscosity, and excellent adhesion to a recording medium.

In the present invention, in order to further improve the non-tackiness (surface tackiness) and the transparency, among the above-mentioned radically polymerizable compounds, it is preferable to use a polyfunctional (meth)acrylate compound in combination.

Particularly preferred examples of the polyfunctional (meth)acrylate include bisphenol A epoxy di(meth)acrylate and tripropylene glycol di(meth)acrylate.

When a polyfunctional ethylenically unsaturated compound is used, the content of the polyfunctional ethylenically unsaturated compound, relative to the total weight of the coating composition, is preferably 5 to 80 wt %, and more preferably 40 to 70 wt %. When the content is in the above-mentioned range, the non-tackiness is excellent.

From the viewpoint of non-tackiness, the photocurable coating composition of the present invention preferably comprises a (meth)acrylate compound represented by Formula (M) below, and more preferably an acrylate compound represented by Formula (M) below.

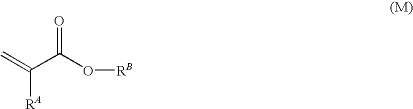

In Formula (M), R^{A} denotes a hydrogen atom or a methyl group, R^{B} denotes an alkyl group having 6 to 18 carbon atoms, more preferably a straight-chain alkyl group having 6 to 18 carbon atoms, and yet more preferably a straight-chain alkyl group having 6 to 12 carbon atoms.

Furthermore, in the photocurable coating composition of the present invention, with regard to the (meth)acrylate compound represented by Formula (M), it may not be used, one type thereof may be used on its own, or two or more types thereof may be used in combination.

Moreover, the photocurable coating composition of the present invention preferably comprises, relative to the total weight of the coating composition, 1 to 80 wt % of a (meth)acrylate compound represented by Formula (M), more preferably 5 to 70 wt %, and yet more preferably 10 to 60 wt %. When in the above-mentioned range, the non-tackiness and surface smoothness are excellent.

As the radically polymerizable compound, it is preferable to use a radically polymerizable compound having an N-vinyl group and a group having a cyclic structure. Among them, it is preferable to use N-vinylcarbazole, 1-vinylimidazole, or an N-vinyllactam, and it is more preferable to use an N-vinyllactam.

Preferred examples of the N-vinyllactam that can be used in the present invention include a compound represented by Formula (N) below.

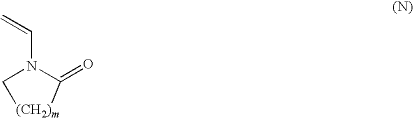

In Formula (N), m denotes an integer of 1 to 5; m is preferably an integer of 2 to 4 from the viewpoint of ease of availability of starting material, m is more preferably an integer of 2 or 4, and m is particularly preferably 4, which is N-vinylcaprolactam. N-vinylcaprolactam is preferable since it has excellent safety, is commonly used and easily available at a relatively low price Furthermore, the N-vinyllactam may have a substituent such as an alkyl group having no greater than 20 carbons, or an aryl group having no greater than 20 carbons, on the lactam ring, and may have a saturated or unsaturated ring structure having no greater than 20 carbons bonded thereto. The N-vinyllactam above may be contained in the ink composition singly or in a combination of a plurality of types thereof.

As the radically polymerizable compound, it is preferable to use a radically polymerizable compound having a cyclic structure.

As the radically polymerizable monomer having a cyclic structure, it is more preferable to use a monofunctional radically polymerizable compound having an alicyclic structure and/or an aromatic monofunctional radically polymerizable compound.

The monofunctional radically polymerizable compound having an aliphatic cyclic structure and the aromatic monofunctional radically polymerizable compound are preferably monofunctional radically polymerizable compounds represented by Formula (A1) below.

The monofunctional radically polymerizable compound having an aliphatic cyclic structure is a monofunctional radically polymerizable compound having an alicyclic hydrocarbon group that may contain a heteroatom, and the aromatic monofunctional radically polymerizable compound is a monofunctional radically polymerizable monomer having an aromatic group.

Furthermore, the monofunctional radically polymerizable compound is a compound having only one polymerizable ethylenically unsaturated bond, and preferred examples of a group having a polymerizable ethylenically unsaturated bond include an acryloyloxy group, a methacryloyloxy group, an acrylamide group, a methacrylamide group, a vinyl group, and a vinyloxy group.

The radically polymerizable compound having an aliphatic cyclic structure has a radically polymerizable group in addition to the aliphatic cyclic structure, and an ethylenically unsaturated bond present within the aliphatic cyclic structure does not correspond to the polymerizable ethylenically unsaturated bond.

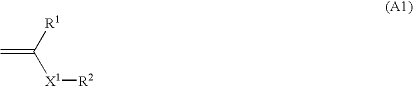

In Formula (A1) above, R¹ denotes a hydrogen atom, a halogen atom, or an alkyl group having 1 to 4 carbons, X¹ denotes a single bond, an ether bond (—O—), an ester bond (—C(O)O— or —OC(O)—), an amide bond (—C(O)NH— or —NHC(O)—), a carbonyl bond (—C(O)—), an optionally branched alkylene group having no greater than 20 carbons, or a second divalent linking group in which a combination thereof are bonded, and it is preferable for X¹ to be the first divalent linking group alone or one having an ether bond, an ester bond, and/or an alkylene group having no greater than 20 carbons when it has the second divalent linking group.

R² is an aromatic group such as a monocyclic aromatic group or a polycyclic aromatic group, or an alicyclic hydrocarbon group; the aromatic group and the alicyclic hydrocarbon group may have a halogen atom, a hydroxyl group, an amino group, a siloxane group, or a substituent having no greater than 30 carbons, and the ring structure of the aromatic group and the alicyclic hydrocarbon group may contain a heteroatom such as O, N, or S.

In Formula (A1) above, R¹ is preferably a hydrogen atom or an alkyl group having 1 to 4 carbons, more preferably a hydrogen atom or a methyl group, and particularly preferably a hydrogen atom.

Furthermore, X¹ is preferably one having an ester bond (—C(O)O—).

That is, in the present invention, the monofunctional radically polymerizable compound having an aliphatic cyclic structure and the aromatic monofunctional radically polymerizable compound are preferably an acrylate (acrylic acid ester) or a methacrylate (methacrylic acid ester).

R² of Formula (A1) may be an alicyclic hydrocarbon group. Furthermore, it may be a group having an alicyclic hydrocarbon group containing a heteroatom such as O, N, or S.

The alicyclic hydrocarbon group may be a group having a cycloalkane with 3 to 12 carbons.

Specific examples of the alicyclic hydrocarbon group containing a heteroatom such as O, N, or S include groups formed by removing at least one hydrogen from pyrrolidine, pyrazolidine, imidazolidine, isooxazolidine, isothiazolidine, piperidine, piperazine, morpholine, thiomorpholine, diazole, triazole, and tetrazole.

The alicyclic hydrocarbon group and the heterocycle-containing alicyclic hydrocarbon group may have a substituent, and the substituent is preferably a halogen atom, a hydroxyl group, an amino group, a mercapto group, a siloxane group, an optionally substituted hydrocarbon group having a total of no greater than 30 carbons, a heterocyclic group containing a heteroatom such as O, N, or S, or an oxy group (═O) as a divalent substituent.

The monofunctional radically polymerizable compound having an aliphatic cyclic structure is preferably a compound having a norbornane skeleton represented by Formula (A2) below.

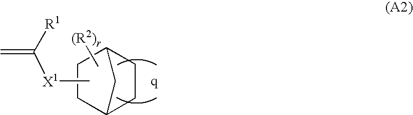

In Formula (A2) it is preferable that R¹ denotes a hydrogen atom, a halogen atom, or an alkyl group having 1 to 4 carbons, and X¹ denotes a divalent linking group, and preferably an ether group (—O—), an ester group (—C(O)O— or —OC(O)—), an amide group (—C(O)NR′—), a carbonyl group (—C(O)—), a nitrogen atom (—NR′—), an optionally substituted alkylene group having 1 to 15 carbons, or a divalent group in which two or more thereof are combined. R′ denotes a hydrogen atom, a straight-chain, branched, or cyclic alkyl group having 1 to 20 carbons, or an aryl group having 6 to 20 carbons. R² denotes a substituent, r denotes an integer of 0 to 5, q denotes a cyclic hydrocarbon structure, the cyclic hydrocarbon structure may comprise a carbonyl bond (—C(O)—) and/or an ester bond (—C(O)O—) in addition to a hydrocarbon bond, the r R²s may be identical to or different from each other, and one carbon atom in the norbornane skeleton may be replaced by an ether bond (—O—) and/or an ester bond (—C(O)O—).

In Formula (A2), R¹ is preferably a hydrogen atom or an alkyl group having 1 to 4 carbons, and more preferably a hydrogen atom or a methyl group.

The end of X¹ in Formula (A2) that is bonded to the vinyl group is preferably an ester group or an amide group via which a carbonyl carbon of X¹ is bonded to the vinyl group, and is more preferably an ester bond. One having the structure H₂C═C(R¹)—C(O)O— is particularly preferable. In this case, another moiety of X¹ that is bonded to the norbornane skeleton may be a single bond or one freely selected from the groups above.

The vinyl moiety containing R¹ and X¹ (H₂C=C(R¹)-X¹-) may be bonded to any position of the alicyclic hydrocarbon structure. The ‘alicyclic hydrocarbon structure’ means the norbornane structure and the cyclic hydrocarbon structure comprising q of Formula (A2).

From the viewpoint of improving affinity with a colorant, the end of X¹ bonded to the alicyclic hydrocarbon structure in Formula (A2) is preferably an oxygen atom, and more preferably an ethereal oxygen atom, and X¹ in Formula (A2) is yet more preferably —C(O)O(CH₂CH₂O)ₚ— (p denotes 1 or 2).

The R²s in Formula (A2) independently denote a substituent that may be bonded to any position on the alicyclic hydrocarbon structure. Furthermore, the r R²s may be identical to or different from each other.

The r R²s may independently be a monovalent or polyvalent substituent; the monovalent substituent is preferably a hydrogen atom, a hydroxyl group, a substituted or unsubstituted amino group, a mercapto group, a siloxane group, or an optionally substituted hydrocarbon group or heterocyclic group having a total of no greater than 30 carbons, and a divalent substituent is preferably an oxy group (═O).

The substitution number r for R² denotes an integer of 0 to 5.

q in Formula (A2) denotes a cyclic hydrocarbon structure whose opposite termini may substitute any positions of the norbornane skeleton; it may be a monocyclic structure or a polycyclic structure, and it may contain a carbonyl bond (—C(O)—) and/or an ester bond (—C(O)O—) as well as the hydrocarbon bonds in the cyclic hydrocarbon structure.

The compound represented by Formula (A2) above is preferably a compound represented by Formula (A3) or Formula (A4). The unsaturated bond in the cyclic hydrocarbon structure of Formula (A4) has low radical polymerizability, and in the present invention a compound represented by Formula (A4) is considered as a monofunctional radically polymerizable monomer.

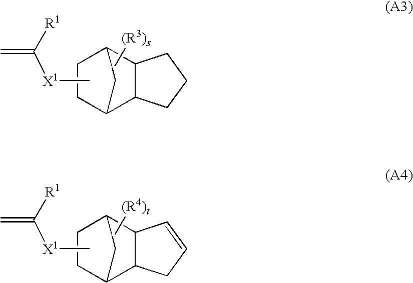

In Formula (A3) and Formula (A4), R¹ denotes a hydrogen atom, a halogen atom, or an alkyl group having 1 to 4 carbons, X¹ denotes a divalent linking group, R³ and R⁴ independently denote a substituent, s and t independently denote an integer of 0 to 5, and the s R³s and the t R⁴s may be identical to or different from each other.

R¹ and X¹ in Formula (A3) or Formula (A4) have the same meanings as those of R¹ and X¹ in Formula (A2) and preferred ranges are also the same.

The vinyl moiety containing R¹ and X¹ in Formula (A3) or Formula (A4) may be bonded to any position on the alicyclic hydrocarbon structures in Formula (A3) and Formula (A4) below.

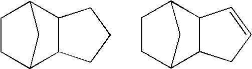

R³ and R⁴ in Formula (A3) and Formula (A4) independently denote a substituent, and it may be bonded to any position on the alicyclic hydrocarbon structures in Formula (A3) and Formula (A4). The substituent denoted by R³ or R⁴ has the same meaning as that of the substituent denoted by R² in Formula (A2), and a preferred range is also the same.

s and t in Formula (A3) or Formula (A4) independently denote an integer of 0 to 5, and the s R³s and the t R⁴s may be identical to or different from each other.

Preferred specific examples of monofunctional acrylates as the monomer represented by Formula (A2) are shown below. In the specific examples below, (M-13)is specially preferable.

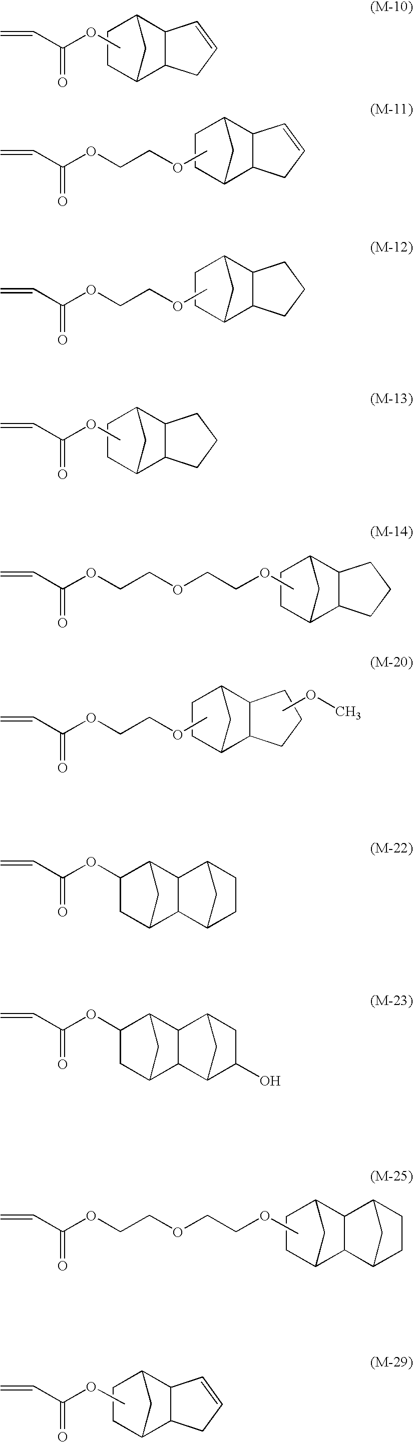

Preferred specific examples of monofunctional methacrylates as the compound represented by Formula (A2) are shown below.

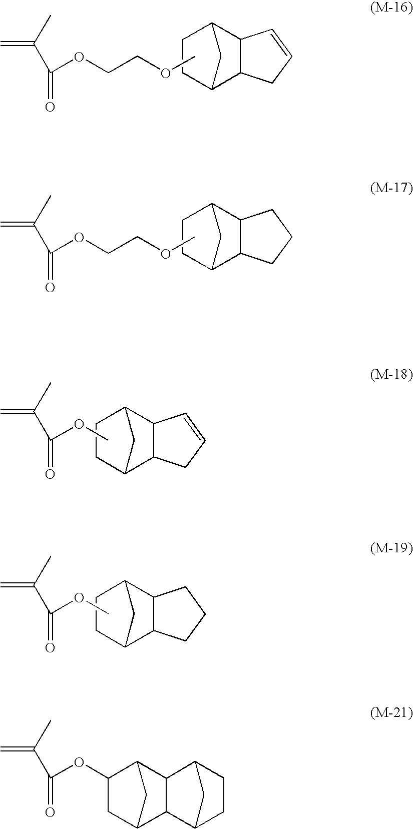

A preferred specific example of a monofunctional acrylamide as the compound represented by Formula (A2) is shown below.

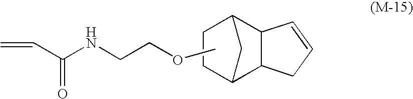

The coating composition of the present invention preferably comprises as the radically polymerizable compound an aromatic monofunctional radically polymerizable compound.

The aromatic monofunctional radically polymerizable compound is preferably a compound represented by Formula (A5) below.

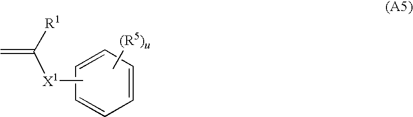

In Formula (A5), R¹ denotes a hydrogen atom, a halogen atom, or an alkyl group having 1 to 4 carbons, X¹ denotes a divalent linking group, R⁵ denotes a substituent, u denotes an integer of 0 to 5, the u R⁵s may be identical to or different from each other, the plurality of R⁵s may be bonded to each other to form a ring, and the ring may be an aromatic ring.

In Formula (A5), R¹ is preferably a hydrogen atom or an alkyl group having 1 to 4 carbons, more preferably a hydrogen atom or a methyl group, and yet more preferably a hydrogen atom.

X¹ has the same meaning as that of X¹ in Formula (A2), and a preferred range is also the same.

The u R⁵s may independently be a monovalent or polyvalent substituent, and the monovalent substituent is preferably a hydrogen atom, a hydroxy group, a substituted or unsubstituted amino group, thiol group, or siloxane group, or an optionally substituted hydrocarbon group or heterocyclic group having a total number of carbons of no greater than 30.

In Formula (A5), the plurality of R⁵s preferably form an aromatic ring when they are bonded to each other to form a ring.

That is, in Formula (A5), the aromatic group is preferably a group (a phenyl group, a phenylene group, etc.) in which at least one hydrogen is removed from benzene, which is a monocyclic aromatic group, or a polycyclic aromatic group having 2 to 4 rings, but is not limited thereto. Specific examples thereof include a group in which at least one hydrogen atom is removed from naphthalene, anthracene, 1H-indene, 9H-fluorene, 1H-phenalene, phenanthrene, triphenylene, pyrene, naphthacene, tetraphenylene, biphenylene, as-indacene, s-indacene, acenaphthylene, fluoranthene, acephenanthrylene, aceanthrylene, chrysene, or pleiadene.

These aromatic groups may be aromatic heterocyclic groups containing a heteroatom such as O, N, or S. Specific examples thereof include a group in which at least one hydrogen atom is removed from a monocyclic aromatic heterocyclic compound such as furan, thiophene, 1H-pyrrole, 2H-pyrrole, 1H-pyrazole, 1H-imidazole, isoxazole, isothiazole, 2H-pyran, 2H-thiopyran, pyridine, pyridazine, pyrimidine, pyrazine, 1,2,3-triazole, or 1,2,4-triazole.

Furthermore, examples include a group in which at least one hydrogen atom is removed from a polycyclic aromatic heterocyclic compound such as thianthrene, isobenzofuran, isochromene, 4H-chromene, xanthene, phenoxathiine, indolizine, isoindole, indole, indazole, purine, 4H-quinolizine, isoquinoline, quinoline, phthalazine, naphthyridine, quinoxaline, quinazoline, cinnoline, pteridine, carbazole, β-carboline, phenanthridine, acridine, perimidine, phenanthroline, phenazine, phenothiazine, phenoxazine, or pyrrolidine.

These aromatic groups may have one or more halogen atom, hydroxy group, amino group, mercapto group, siloxane group, or substituent having no greater than 30 carbons. A cyclic structure containing a heteroatom such as O, N, or S may be formed from two or more substituents possessed by the aromatic group as in, for example, phthalic anhydride or phthalimide anhydride.

Among them, as the aromatic monofunctional radically polymerizable compound, 2-phenoxyethyl (meth)acrylate is preferable, and 2-phenoxyethyl acrylate is more preferable.

In the present invention, depending on various purposes, in addition to the combination of a radically polymerizable compound and a radical photopolymerization initiator and the combination of a cationically polymerizable compound and a cationic photopolymerization initiator, a radical-cationic hybrid coating composition in which the above combinations are combined may also be used.

### Cationically Polymerizable Compound

The cationically polymerizable compound in the present invention is not particularly limited as long as it is a compound that undergoes a cationic polymerization reaction by the application of some type of energy and cures; any type of monomer, oligomer, or polymer may be used and, in particular, various types of known cationically polymerizable monomers, known as cationically photopolymerizable monomers, that undergo a polymerization reaction by an initiating species generated from the cationic polymerization initiator above mentioned may be used. Moreover, the cationically polymerizable compound may be a monofunctional compound or a polyfunctional compound.

As the cationically polymerizable compound in the present invention, from the viewpoint of curability and abrasion resistance, an oxetane-ring containing compound and an oxirane ring-containing compound are preferable, and a configuration in which both of an oxetane-ring containing compound and an oxirane ring-containing compound are contained is more preferable.

In the present invention, the oxirane ring-containing compound (hereinafter, also called an ‘oxirane compound’ as appropriate) is a compound containing at least one oxirane ring (oxiranyl group, epoxy group) per molecule; it may be appropriately selected from those normally used as epoxy resins, and specific examples thereof include conventionally known aromatic epoxy resins, alicyclic epoxy resins, and aliphatic epoxy resins. It may be any one of a monomer, an oligomer, and a polymer. Furthermore, the oxetane-ring containing compound (hereinafter, also called an ‘oxetane compound’ as appropriate) is a compound containing at least one oxetane ring (oxetanyl group) per molecule.

The cationically polymerizable compound used in the present invention is now explained in detail.

Examples of the cationically polymerizable monomer include epoxy compounds, vinyl ether compounds, oxetane compounds described in JP-A-6-9714, JP-A-2001-31892, JP-A-2001-40068, JP-A-2001-55507, JP-A-2001-310938, JP-A-2001-310937, JP-A-2001-220526, etc.

Examples of monofunctional epoxy compounds used in the present invention include phenyl glycidyl ether, p-tert-butylphenyl glycidyl ether, butyl glycidyl ether, 2-ethylhexyl glycidyl ether, allyl glycidyl ether, 1,2-butylene oxide, 1,3-butadiene monooxide, 1,2-epoxydodecane, epichlorohydrin, 1,2-epoxydecane, styrene oxide, cyclohexene oxide, 3-methacryloyloxymethylcyclohexene oxide, 3-acryloyloxymethylcyclohexene oxide, and 3-vinylcyclohexene oxide.

Furthermore, examples of polyfunctional epoxy compounds include bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, epoxy novolac resins, hydrogenated bisphenol A diglycidyl ether, hydrogenated bisphenol F diglycidyl ether, hydrogenated bisphenol S diglycidyl ether, 3,4-epoxycyclohexenylmethyl-3′,4′-epoxycyclohexenecarboxylate, 2-(3,4-epoxycyclohexyl)-7,8-epoxy-1,3-dioxaspiro[5.5]undecane, bis(3,4-epoxycyclohexylmethyl)adipate, vinylcyclohexene dioxide, 4-vinylepoxycyclohexane, bis(3,4-epoxy-6-methylcyclohexylmethyl)adipate, 3,4-epoxy-6-methylcyclohexenyl 3′,4′-epoxy-6′-methylcyclohexenecarboxylate, methylenebis(3,4-epoxycyclohexane), dicyclopentadiene diepoxide, the di(3,4-epoxycyclohexylmethyl)ether of ethylene glycol, ethylene bis(3,4-epoxycyclohexanecarboxylate), dioctyl epoxyhexahydrophthalate, di-2-ethylhexyl epoxyhexahydrophthalate, 1,4-butanediol diglycidyl ether, 1,6-hexanediol diglycidyl ether, glycerol triglycidyl ether, trimethylolpropane triglycidyl ether, polyethylene glycol diglycidyl ether, polypropylene glycol diglycidyl ether, 1,13-tetradecadiene dioxide, limonene dioxide, 1,2,7,8-diepoxyoctane, and 1,2,5,6-diepoxycyclooctane.

Among these epoxy compounds, the aromatic epoxides and the alicyclic epoxides are preferable from the viewpoint of excellent curing speed, and the alicyclic epoxides are particularly preferable.

Specific examples of monofunctional vinyl ethers used in the present invention include methyl vinyl ether, ethyl vinyl ether, propyl vinyl ether, n-butyl vinyl ether, t-butyl vinyl ether, 2-ethylhexyl vinyl ether, n-nonyl vinyl ether, lauryl vinyl ether, cyclohexyl vinyl ether, cyclohexylmethyl vinyl ether, 4-methylcyclohexylmethyl vinyl ether, benzyl vinyl ether, dicyclopentenyl vinyl ether, 2-dicyclopentenoxyethyl vinyl ether, methoxyethyl vinyl ether, ethoxyethyl vinyl ether, butoxyethyl vinyl ether, methoxyethoxyethyl vinyl ether, ethoxyethoxyethyl vinyl ether, methoxypolyethylene glycol vinyl ether, tetrahydrofurfuryl vinyl ether, 2-hydroxyethyl vinyl ether, 2-hydroxypropyl vinyl ether, 4-hydroxybutyl vinyl ether, 4-hydroxymethylcyclohexylmethyl vinyl ether, diethylene glycol monovinyl ether, polyethylene glycol vinyl ether, chloroethyl vinyl ether, chlorobutyl vinyl ether, chloroethoxyethyl vinyl ether, phenylethyl vinyl ether, and phenoxypolyethylene glycol vinyl ether.

Furthermore, examples of polyfunctional vinyl ethers include divinyl ethers such as ethylene glycol divinyl ether, diethylene glycol divinyl ether, polyethylene glycol divinyl ether, propylene glycol divinyl ether, butylene glycol divinyl ether, hexanediol divinyl ether, bisphenol A alkylene oxide divinyl ether, and bisphenol F alkylene oxide divinyl ether; and polyfunctional vinyl ethers such as trimethylolethane trivinyl ether, trimethylolpropane trivinyl ether, ditrimethylolpropane tetravinyl ether, glycerol trivinyl ether, pentaerythritol tetravinyl ether, dipentaerythritol pentavinyl ether, dipentaerythritol hexavinyl ether, an ethylene oxide adduct of trimethylolpropane trivinyl ether, a propylene oxide adduct of trimethylolpropane trivinyl ether, an ethylene oxide adduct of ditrimethylolpropane tetravinyl ether, a propylene oxide adduct of ditrimethylolpropane tetravinyl ether, an ethylene oxide adduct of pentaerythritol tetravinyl ether, a propylene oxide adduct of pentaerythritol tetravinyl ether, an ethylene oxide adduct of dipentaerythritol hexavinyl ether, and a propylene oxide adduct of dipentaerythritol hexavinyl ether.

As the vinyl ether compound, the di- or tri-vinyl ether compounds are preferable from the viewpoint of curability, adhesion to a recording medium, surface hardness of the image formed, etc., and the divinyl ether compounds are particularly preferable.

The oxetane compound in the present invention may be selected freely from known oxetane compounds such as those described in JP-A-2001-220526, JP-A-2001-310937, and JP-A-2003-341217.

As the oxetane compound that can be used in the present invention, a compound having 1 to 4 oxetane rings in its structure is preferable.

Examples of monofunctional oxetane compounds used in the present invention include 3-ethyl-3-hydroxymethyloxetane, 3-allyloxymethyl-3-ethyloxetane, (3-ethyl-3-oxetanylmethoxy)methylbenzene, 4-fluoro-[1-(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl (3-ethyl-3-oxetanylmethyl)ether, isobornyloxyethyl (3-ethyl-3-oxetanylmethyl)ether, isobornyl (3-ethyl-3-oxetanylmethyl)ether, 2-ethylhexyl (3-ethyl-3-oxetanylmethyl)ether, ethyl diethylene glycol (3-ethyl-3-oxetanylmethyl)ether, dicyclopentadiene (3-ethyl-3-oxetanylmethyl)ether, dicyclopentenyloxyethyl (3-ethyl-3-oxetanylmethyl)ether, dicyclopentenyl (3-ethyl-3-oxetanylmethyl)ether, tetrahydrofurfuryl (3-ethyl-3-oxetanylmethyl)ether, tetrabromophenyl (3-ethyl-3-oxetanylmethyl)ether, 2-tetrabromophenoxyethyl (3-ethyl-3-oxetanylmethyl)ether, tribromophenyl (3-ethyl-3-oxetanylmethyl)ether, 2-tribromophenoxyethyl (3-ethyl-3-oxetanylmethyl)ether, 2-hydroxyethyl (3-ethyl-3-oxetanylmethyl)ether, 2-hydroxypropyl (3-ethyl-3-oxetanylmethyl)ether, butoxyethyl (3-ethyl-3-oxetanylmethyl)ether, pentachlorophenyl (3-ethyl-3-oxetanylmethyl)ether, pentabromophenyl (3-ethyl-3-oxetanylmethyl)ether, and bornyl (3-ethyl-3-oxetanylmethyl)ether.

Examples of polyfunctional oxetane compounds include 3,7-bis(3-oxetanyl)-5-oxanonane, 3,3′-(1,3-(2-methylenyl)propanediylbis(oxymethylene))bis-(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, dicyclopentenylbis(3-ethyl-3-oxetanylmethyl)ether, triethylene glycol bis(3-ethyl-3-oxetanylmethyl)ether, tetraethylene glycol bis(3-ethyl-3-oxetanylmethyl)ether, tricyclodecanediyldimethylene (3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexakis(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, ethylene oxide (EO)-modified bisphenol A bis(3-ethyl-3-oxetanylmethyl)ether, propylene oxide (PO)-modified bisphenol A bis(3-ethyl-3-oxetanylmethyl)ether, EO-modified hydrogenated bisphenol A bis(3-ethyl-3-oxetanylmethyl)ether, PO-modified hydrogenated bisphenol A bis(3-ethyl-3-oxetanylmethyl)ether, and EO-modified bisphenol F (3-ethyl-3-oxetanylmethyl)ether.

Such oxetane compounds are described in detail in Paragraph Nos. 0021 to 0084 of JP-A-2003-341217, and compounds described therein can be used suitably in the present invention.

Among the oxetane compounds that can be used in the present invention, it is preferable to use a compound having 1 to 2 oxetane rings.

In the present invention, with regard to these cationically polymerizable compounds, one type thereof may be used or two or more types may be used in combination.

From the viewpoint of curability and surface smoothness, the content of polymerizable compound (B) in the photocurable coating composition of the present invention, relative to the total weight of the coating composition, is preferably in the range of 10 to 97 wt %, more preferably in the range of 30 to 95 wt %, and particularly preferably in the range of 50 to 90wt %.

Furthermore, with regard to the polymerizable compound (B), one type thereof may be used or two or more types may be used in combination.

### Sensitizer

A sensitizer may be added to the coating composition of the present invention in order to promote decomposition of the photopolymerization initiator by irradiation with actinic radiation.

The sensitizer absorbs specific actinic radiation and attains an electronically excited state. The sensitizer in the electronically excited state contacts the photopolymerization initiator and causes an action such as electron transfer, energy transfer, or generation of heat, thereby promoting chemical change of the photopolymerization initiator, that is, decomposition and generation of a radical, an acid, or a base.

With regard to the sensitizer that can be used in the present invention, it is preferable to use a compound or an amount for which effects such as coloring are small when the coating composition of the present invention is used in an overprint.

The content of the sensitizer in the present invention, relative to the total weight of the coating composition, is preferably 0.001 to 5 wt %, and more preferably 0.01 to 3 wt %. When the amount thereof added is in this range, the curability improves and there is little coloring effect.

As the sensitizer, a compound may be used that is appropriate for the wavelength of actinic radiation that generates an initiating species in the photopolymerization initiator used, but taking into consideration use in a curing reaction of a normal coating composition, preferred examples of the sensitizer include the types of compounds that come under those listed below and that have an absorption wavelength in the range of 350 nm to 450 nm.

Polynuclear aromatic compounds (e.g. pyrene, perylene, triphenylene), xanthenes (e.g. fluorescein, eosin, erythrosine, rhodamine B, rose bengal), cyanines (e.g. thiacarbocyanine, oxacarbocyanine), merocyanines (e.g. merocyanine, carbomerocyanine), thiazines (e.g. thionine, methylene blue, toluidine blue), acridines (e.g. acridine orange, chloroflavin, acriflavine), anthraquinones (e.g. anthraquinone), squaryliums (e.g. squarylium), coumarins (e.g. 7-diethylamino-4-methylcoumarin), and benzophenones (e.g. benzophenone).

Preferred examples of the sensitizer include compounds represented by Formulae (II) to (VI) below.

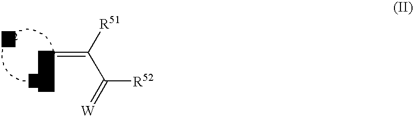

In Formula (II), A¹ denotes a sulfur atom or NR⁵⁰, R⁵⁰ denotes an alkyl group or an aryl group, L² denotes a non-metallic atomic group forming a basic nucleus in cooperation with the adjacent A¹ and carbon atom, R⁵¹ and R⁵² independently denote a hydrogen atom or a monovalent non-metallic atomic group, and R⁵¹ and R⁵² may be bonded together to form an acidic nucleus. W denotes an oxygen atom or a sulfur atom.

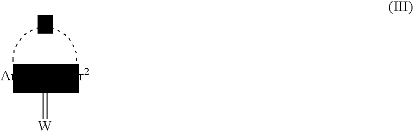

In Formula (III), Ar¹ and Ar² independently denote an aryl group and are connected to each other via bonding to -L³-. Here, L³ denotes —O— or —S—. W has the same meaning as that shown in Formula (II).

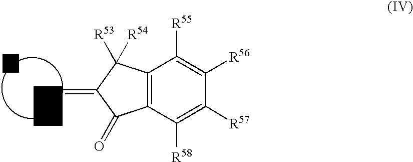

In Formula (IV), A² denotes a sulfur atom or NR⁵⁹, L⁴ denotes a non-metallic atomic group forming a basic nucleus in cooperation with the adjacent A² and carbon atom, R⁵³, R⁵⁴, R⁵⁵, R⁵⁶, R⁵⁷, and R⁵⁸ independently denote a monovalent non-metallic atomic group, and R⁵⁹ denotes an alkyl group or an aryl group.

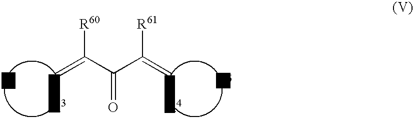

In Formula (V), A³ and A⁴ independently denote —S—, —NR⁶²—, or —NR⁶³—, R⁶² and R⁶³ independently denote a substituted or unsubstituted alkyl group, or a substituted or unsubstituted aryl group, L⁵ and L⁶ independently denote a non-metallic atomic group forming a basic nucleus in cooperation with the adjacent A³ and A⁴ and adjacent carbon atom, and R⁶⁰ and R⁶¹ independently denote a hydrogen atom or a monovalent non-metallic atomic group, or are bonded to each other to form an aliphatic or aromatic ring.

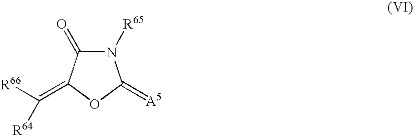

In Formula (VI), R⁶⁶ denotes an optionally substituted aromatic ring or hetero ring, and A⁵ denotes an oxygen atom, a sulfur atom, or NR⁶⁷. R⁶⁴, R⁶⁵, and R⁶⁷ independently denote a hydrogen atom or a monovalent non-metallic atomic group, and R⁶⁷ and R⁶⁴, and R⁶⁵ and R⁶⁷ may be bonded to each other to form an aliphatic or aromatic ring.

Preferred specific examples of the compound represented by Formulae (II) to (VI) are listed below. In the specific example listed below, ‘Ph’ denotes a phenyl group and ‘Me’ denotes a methyl group.

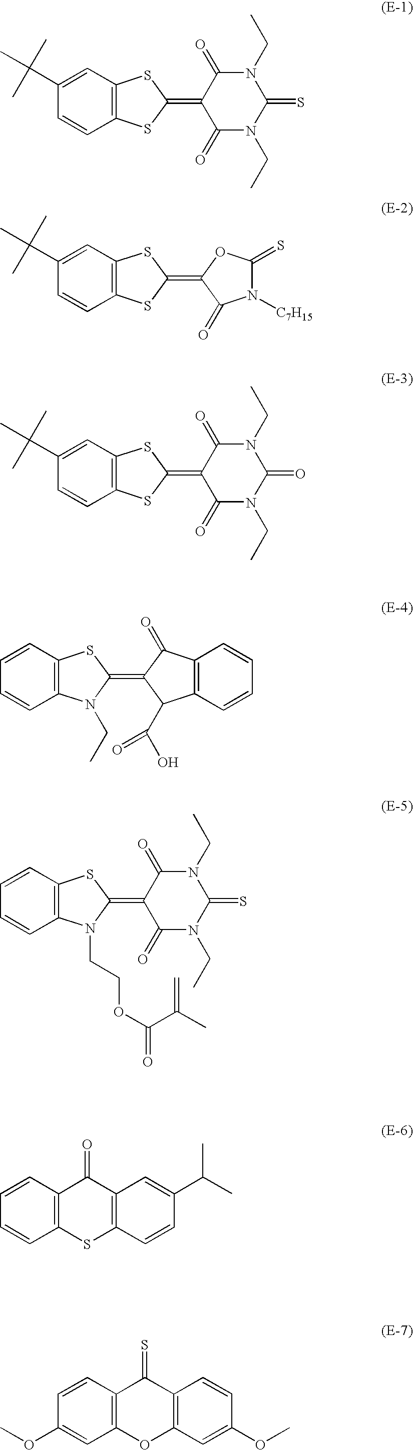

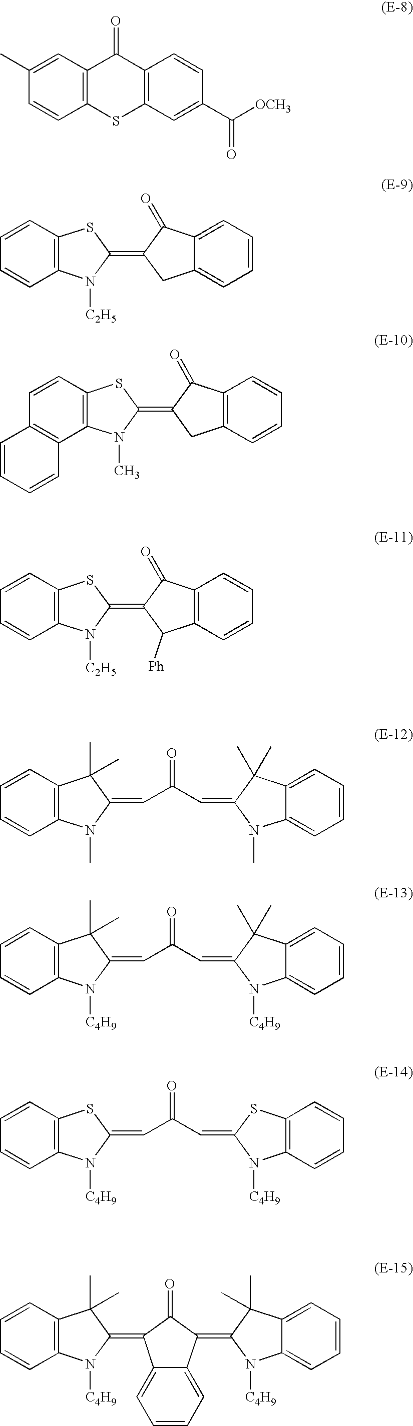

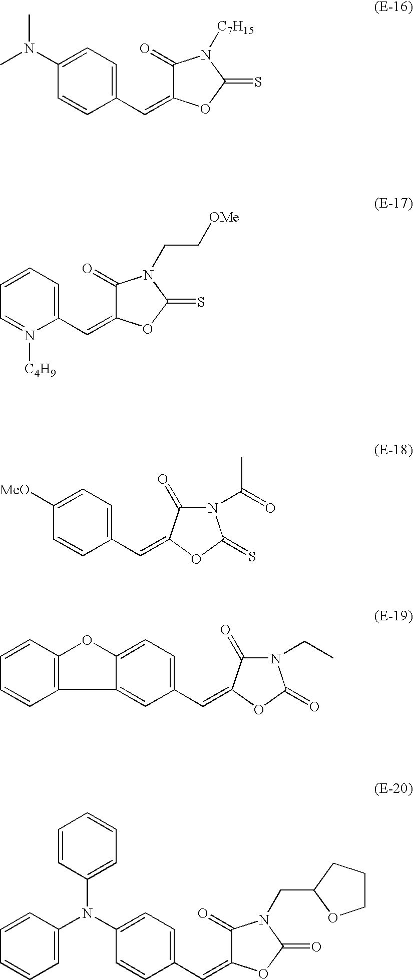

### Co-Sensitizer

The coating composition of the present invention may comprise a co-sensitizer.

In the present invention, the co-sensitizer has a function of further improving the sensitivity of a sensitizer toward actinic radiation, suppressing inhibition of polymerization of a polymerizable compound by oxygen, etc.

Examples of such a co-sensitizer include amines such as compounds described in M. R. Sander et al., Journal of Polymer Society, Vol. 10, p. 3173 (1972), JP-B-44-20189, JP-A-51-82102, JP-A-52-134692, JP-A-59-138205, JP-A-60-84305, JP-A-62-18537, JP-A-64-33104, and Research Disclosure 33825.

Specific examples thereof include triethanolamine, ethyl p-dimethylaminobenzoate, p-formyldimethylaniline, and p-methylthiodimethylaniline.

Other examples of the co-sensitizer include thiols and sulfides such as thiol compounds described in JP-A-53-702, JP-PCT-55-500806 (JP-PCT denotes a published Japanese translation of a PCT application), and JP-A-5-142772, and disulfide compounds described in JP-A-56-75643.

Specific examples thereof include 2-mercaptobenzothiazole, 2-mercaptobenzoxazole, 2-mercaptobenzoimidazole, 2-mercapto-4(3H)-quinazoline, and p-mercaptonaphthalene.

Other examples thereof include amino acid compounds (e.g. N-phenylglycine), organometallic compounds described in JP-B-48-42965 (e.g. tributyltin acetate), hydrogen donors described in JP-B-55-34414, sulfur compounds described in JP-A-6-308727 (e.g. trithiane), phosphorus compounds described in JP-A-6-250387 (e.g. diethylphosphite), and Si—H and Ge—H compounds described in JP-A-8-54735.

### Surfactant

The coating composition of the present invention may comprise a surfactant.

As the surfactant, those described in JP-A-62-173463 and JP-A-62-183457 can be cited. Examples thereof include anionic surfactants such as dialkylsulfosuccinic acid salts, alkylnaphthalenesulfonic acid salts, and fatty acid salts, nonionic surfactants such as polyoxyethylene alkyl ethers, polyoxyethylene alkyl aryl ethers, acetylene glycols, and polyoxyethylene/polyoxypropylene block copolymers, and cationic surfactants such as alkylamine salts and quaternary ammonium salts. An organofluoro compound or a polysiloxane compound may be used as the surfactant. The organofluoro compound is preferably hydrophobic. Examples of the organofluoro compound include fluorine-based surfactants, oil-like fluorine-based compounds (e.g. fluorine oil), solid fluorine compound resins (e.g. tetrafluoroethylene resin), and those described in JP-B-57-9053 (paragraphs 8 to 17) and JP-A-62-135826. Among them, polydimethylsiloxane is preferable as the surfactant.

The surfactant may be used on its own or in a combination of two or more types.

### Other Components

Other components may be added to the coating composition of the present invention as necessary. Examples of said other components include a polymerization inhibitor, a solvent, inorganic particles, and organic particles.

The polymerization inhibitor may be added from the viewpoint of enhancing the storage stability. The polymerization inhibitor is preferably added at 200 to 20,000 ppm relative to the total amount of the coating composition of the present invention.

Examples of the polymerization inhibitor include hydroquinone, benzoquinone, p-methoxyphenol, TEMPO, TEMPOL, and Al cupferron.

It is possible to form an overprint layer or an overprint with intentionally degraded surface gloss by adding inorganic particles such as AEROSIL (Silicon Dioxide particle, manufactured by EVONIK INDUSTRIES) or organic particles such as crosslinked polymethyl methacrylate (PMMA) to the coating composition of the present invention.

Taking into consideration the coating composition of the present invention being a radiation curing type coating composition, it is preferable for it not to contain any solvent so that the coating composition of the present invention can react quickly and be cured after coating. However, as long as the curing speed, etc. of the coating composition is not affected, a specified solvent may be added.

In the present invention, an organic solvent may be used as the solvent, and from the viewpoint of curing speed, it is preferable for substantially no water to be added. The organic solvent may be added in order to improve adhesion to a printing substrate (an image receiving substrate such as paper).

When an organic solvent is used, the smaller the amount thereof, the more preferable it is, and it is preferably 0.1 to 5 wt % relative to the total weight of the coating composition of the present invention, and more preferably 0.1 to 3 wt %.

In addition to the above, a known compound may be added to the coating composition of the present invention as necessary.

Examples thereof include a surfactant, a leveling additive, a matting agent and, for adjusting film physical properties, a polyester-based resin, polyurethane-based resin, vinyl-based resin, acrylic-based resin, rubber-based resin, or wax, which may be appropriately selected and added.

Furthermore, in order to improve the adhesion to a printing substrate such as a polyolefin or polyethylene terephthalate (PET), a tackifier that does not inhibit polymerization is preferably added. Specific examples of the tackifier include high molecular weight tacky polymers described on pp. 5 and 6 of JP-A-2001-49200 (e.g. a copolymer formed from an ester of (meth)acrylic acid and an alcohol having an alkyl group having 1 to 20 carbons, an ester of (meth)acrylic acid and an alicyclic alcohol having 3 to 14 carbons, or an ester of (meth)acrylic acid and an aromatic alcohol having 6 to 14 carbons), and a low molecular weight tackifying resin having a polymerizable unsaturated bond.

### Properties of Photocurable Coating Composition

Preferred physical properties of the photocurable coating composition of the present invention are now explained.

When used as a photocurable coating composition, while taking into consideration coating properties, the viscosity at 25° C. to 30° C. is preferably 5 to 100 mPa·s, and more preferably 7 to 75 mPa·s.

The compositional ratio of the photocurable coating composition of the present invention is preferably adjusted as appropriate so that the viscosity is in the above range.

Setting the viscosity at 25° C. to 30° C. at the above value enables an overprint having an overprint layer with excellent non-tackiness (no surface tackiness) and excellent surface smoothness to be obtained.

The surface tension of the photocurable coating composition of the present invention is preferably 16 to 40 mN/m, and more preferably 18 to 35 mN/m.

### Overprint and Process for Producing Same

The overprint of the present invention has, on a printed material, an overprint layer in which the coating composition of the present invention is photocured.

The overprint referred to here is at least one overprint layer formed on the surface of a printed material obtained by a printing method such as electrophotographic printing, inkjet printing, screen printing, flexographic printing, lithographic printing, intaglio printing, or relief printing.

The overprint layer in the overprint of the present invention may be formed on part of a printed material or may be formed on the entire surface of a printed material, and in the case of a double-side printed material, it is preferable to form the overprint layer on the entire surface of a printing substrate on both sides. Furthermore, needless to say, the overprint layer may be formed on an unprinted area of a printed material.

A printed material used for the overprint of the present invention is preferably an electrophotographically printed material. Forming an overprint layer, which is a cured layer of the coating composition of the present invention, on an electrophotographically printed material enables an overprint that has excellent non-tackiness, surface smoothness, and gloss and is visually similar to a silver halide photographic print to be obtained.

Furthermore, since the overprint of the present invention has excellent non-tackiness, even when a plurality of prepared overprints of the present invention are superimposed on each other and stored for a long period of time, the overprints do not stick to each other, and the storage properties are excellent.

The thickness of the overprint layer in the overprint of the present invention is preferably 1 to 10 μm, and more preferably 3 to 6 μm.

A method for measuring the thickness of the overprint layer is not particularly limited, but a preferred example thereof include a measurement method in which a cross section of an overprint is examined using an optical microscope, etc.

A process for producing an overprint of the present invention preferably comprises a step of preparing a printed material by printing on a printing substrate, a step of coating the printed material with a photocurable composition and a step of photocuring the photocurable composition.

Furthermore, the process for producing an overprint of the present invention preferably comprises a step of generating an electrostatic latent image on a latent image support, a step of developing the electrostatic latent image using a toner, a step of obtaining an electrophotographically printed material by transferring the developed electrostatic image onto a printing substrate, a step of coating the electrophotographically printed material with the photocurable coating composition of the present invention, and a step of photocuring the coating composition.

The printing substrate is not particularly limited, and a known substrate may be used, but an image receiving paper is preferable, plain paper or coated paper is more preferable, and coated paper is yet more preferable. As the coated paper, a double-sided coated paper is preferable since a full color image can be attractively printed on both sides. When the printing substrate is paper or a double-sided coated paper, the paper weight is preferably 20 to 200 g/m², and more preferably 40 to 160 g/m².

A method for developing an image in the electrophotographic process is not particularly limited, and any method may be selected from methods known to a person skilled in the art. Examples thereof include a cascade method, a touch down method, a powder cloud method, and a magnetic brush method.

Furthermore, examples of a method for transferring a developed image to a printing substrate include a method employing a corotron or a bias roll.

A fixing step of fixing an image in the electrophotographic process may be carried out by various appropriate methods. Examples thereof include flash fixing, thermal fixing, pressure fixing, and vapor fusing.

The image formation method, equipment, and system in the electrophotographic process are not particularly limited, and known ones may be used. Specific examples are described in the US Patents below.

U.S. Pat. Nos. 4,585,884, 4,584,253, 4,563,408, 4,265,990, 6,180,308, 6,212,347, 6,187,499, 5,966,570, 5,627,002, 5,366,840, 5,346,795, 5,223,368, and 5,826,147.

In order to apply the photocurable coating composition, a commonly used liquid film coating device may be used. Specific examples thereof include a roller coater, a rod coater, a blade, a wire-wound bar, a dip coater, an air knife, a curtain coater, a slide coater, a doctor knife, a screen coater, a gravure coater such as an offset gravure coater, a slot coater, and an extrusion coater. These devices may be used in the same manner as normal, and examples thereof include direct and reverse roll coating, blanket coating, dampener coating, curtain coating, lithographic coating, screen coating, and gravure coating. In a preferred embodiment, application and curing of the coating composition of the present invention are carried out using 2 or 3 roll coaters and UV curing stations.

Moreover, when coating or curing the coating composition of the present invention, heating may be carried out as necessary.

The coat weight of the coating composition of the present invention is preferably in the range of 1 to 10 g/m² as a weight per unit area, and more preferably 3 to 6 g/m².

Furthermore, the amount per unit area of an overprint layer formed in the overprint of the present invention is preferably in the range of 1 to 10 g/m², and more preferably 3 to 6 g/m².

As an energy source used for initiating polymerization of the polymerizable compound contained in the coating composition of the present invention, for example, one having actinism (actinic radiation) such as radiation having a wavelength in the UV or visible spectrum can be cited. Polymerization by irradiation with actinic radiation is excellent for initiating polymerization and regulating the speed of polymerization.

As a preferred actinic radiation source, for example, there are a mercury lamp, a xenon lamp, a carbon arc lamp, a tungsten filament lamp, a laser, and sunlight.

It is preferable to carry out irradiation using a high speed conveyor (preferably 15 to 70 m/min) under irradiation with UV rays (UV light irradiation) using a medium pressure mercury lamp, and in this case UV light irradiation is preferably carried out at a wavelength of 200 to 500 nm for less than 1 sec. Preferably, the speed of the high speed conveyor is 15 to 35 m/min, and UV light having a wavelength of 200 to 450 nm is applied for 10 to 50 milliseconds (ms). The emission spectrum of a UV light source normally overlaps the absorption spectrum of a UV polymerization initiator. Depending on the situation, curing equipment used may include, without being limited to, a reflection plate for focusing or diffusing UV light or a cooling system for removing heat generated by a UV light source. Properties of cured material formed by curing photocurable coating composition A cured material formed by curing the photocurable coating composition of the present invention by irradiation with UV rays (UV light irradiation) preferably has substantially no absorption in the visible region. ‘Having substantially no absorption in the visible region’ means either having no absorption in the visible region of 400 to 700 nm or having only a level of absorption in the visible region that does not cause any problem as a photocurable coating. Specifically, a 5 μm optical path length transmittance of the cured material formed by coating composition in the wavelength region of 400 to 700 nm is at least 70%, and preferably at least 80%.

In accordance with the present invention, there can be provided a photocurable composition giving excellent surface smoothness, non-tackiness (suppression of surface tackiness), and suppression of odor, an overprint obtained by using the photocurable composition, and a process for producing same.

### EXAMPLES

The present invention is explained in further detail by reference to Examples below, but the present invention is not limited to these Examples.

### Example 1

The components below were stirred using a stirrer to give a photocurable coating composition 1.

| | | |
|---|---|---|
| FA-513A (manufactured by Hitachi Chemical Co., Ltd.) | 30 | wt % |
| 2-Phenoxyethyl acrylate | 25 | wt % |
| (manufactured by Tokyo Chemical Industry Co., Ltd.) | | |
| N-Vinylcaprolactam (manufactured by Aldrich) | 25 | wt % |
| Compound (I-1) above | 18 | wt % |
| Polydimethylsiloxane (manufactured by Aldrich) | 2 | wt % |

FA-513A

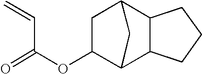

### Examples 2 to 10

In Examples 2 to 10, photocurable coating compositions 2 to 10 were obtained in the same manner as in Example 1 except that compound (1-1) was changed to a compound shown in Table 1.

### Examples 11

The components below were stirred using a stirrer to give a photocurable coating composition 11.

| | |
|---|---|
| Tripropylene glycol diacrylate (manufactured by Aldrich) | 30 wt % |
| Lauryl acrylate (manufactured by Tokyo Chemical Industry | 15 wt % |
| Co., Ltd.) | |
| OTA-480 (Propoxylated glycerol triacrylate, manufactured by | 35 wt % |
| CYTEC SURFACE SPECIALTIES) | |
| Compound (I-1) above | 18 wt % |
| Polydimethylsiloxane (manufactured by Aldrich) | 2 wt % |

### Examples 12 to 20

In Examples 12 to 20, photocurable coating compositions 12 to 20 were obtained in the same manner as in Example 11 except that compound (1-1) was changed to a compound shown in Table 1.

### Comparative Examples 1

The components below were stirred using a stirrer to give a comparative photocurable coating composition 1.

| | | |
|---|---|---|
| FA-513A (manufactured by Hitachi Chemical Co., Ltd.) | 30 | wt % |
| 2-Phenoxyethyl acrylate | 25 | wt % |
| (manufactured by Tokyo Chemical Industry Co., Ltd.) | | |
| N-Vinylcaprolactam (manufactured by Aldrich) | 25 | wt % |
| Compound H-1 below | 18 | wt % |
| Polydimethylsiloxane (manufactured by Aldrich) | 2 | wt % |

H-1

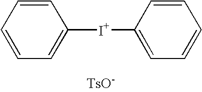

### Comparative Examples 2

The components below were stirred using a stirrer to give a comparative photocurable coating composition 2.

| | | |
|---|---|---|
| FA-513A (manufactured by Hitachi Chemical Co., Ltd.) | 30 | wt % |
| 2-Phenoxyethyl acrylate | 25 | wt % |
| (manufactured by Tokyo Chemical Industry Co., Ltd.) | | |
| N-Vinylcaprolactam (manufactured by Aldrich) | 25 | wt % |
| Compound H-2 below | 18 | wt % |
| Polydimethylsiloxane (manufactured by Aldrich) | 2 | wt % |

H-2

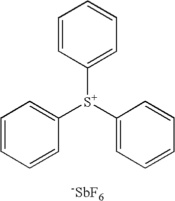

### Comparative Examples 3

The components below were stirred using a stirrer to give a comparative photocurable coating composition 3.

| | | |
|---|---|---|
| FA-513A (manufactured by Hitachi Chemical Co., Ltd.) | 30 | wt % |
| 2-Phenoxyethyl acrylate | 25 | wt % |
| (manufactured by Tokyo Chemical Industry Co., Ltd.) | | |
| N-Vinylcaprolactam (manufactured by Aldrich) | 25 | wt % |
| Compound H-3 below | 18 | wt % |
| Polydimethylsiloxane (manufactured by Aldrich) | 2 | wt % |

H-3

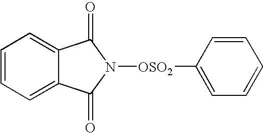

### Comparative Examples 4

The components below were stirred using a stirrer to give a comparative photocurable coating composition 4.

| | |
|---|---|
| Tripropylene glycol diacrylate (manufactured by Aldrich) | 30 wt % |
| Lauryl acrylate (manufactured by Tokyo Chemical Industry Co., | 15 wt % |
| Ltd.) | |
| OTA-480 (Propoxylated glycerol triacrylate, manufactured by | 35 wt % |
| CYTEC SURFACE SPECIALTIES) | |
| Compound H-1 above | 18 wt % |
| Polydimethylsiloxane (manufactured by Aldrich) | 2 wt % |

### Comparative Examples 5

The components below were stirred using a stirrer to give a comparative photocurable coating composition 5.

| | |
|---|---|
| Tripropylene glycol diacrylate (manufactured by Aldrich) | 30 wt % |
| Lauryl acrylate (manufactured by Tokyo Chemical Industry Co., | 15 wt % |
| Ltd.) | |
| OTA-480 (Propoxylated glycerol triacrylate, manufactured by | 35 wt % |
| CYTEC SURFACE SPECIALTIES) | |
| Compound H-2 above | 18 wt % |
| Polydimethylsiloxane (manufactured by Aldrich) | 2 wt % |

### Comparative Examples 6

The components below were stirred using a stirrer to give a comparative photocurable coating composition 6.

| | |
|---|---|
| Tripropylene glycol diacrylate (manufactured by Aldrich) | 30 wt % |
| Lauryl acrylate (manufactured by Tokyo Chemical Industry Co., | 15 wt % |
| Ltd.) | |
| OTA-480 (Propoxylated glycerol triacrylate, manufactured by | 35 wt % |
| CYTEC SURFACE SPECIALTIES) | |
| Compound H-3 above | 18 wt % |
| Polydimethylsiloxane (manufactured by Aldrich) | 2 wt % |

### Examples 21

The components below were stirred using a stirrer to give a comparative photocurable coating composition 21.

| | | |
|---|---|---|
| Tripropylene glycol diacrylate (manufactured by Aldrich) | 30 | wt % |
| NK Ester A-TMPT (SHIN-NAKAMURA CHEMICAL Co, Ltd) | 10 | wt % |
| DPCA-60 (manufactured by NIPPON KAYAKU Co., Ltd.) | 10 | wt % |
| Lauryl acrylate (manufactured by Tokyo Chemical Industry Co., Ltd.) | 20 | wt % |
| Hexyl acrylate (manufactured by Tokyo Chemical Industry Co., Ltd.) | 15 | wt % |
| Compound (I-1) above | 13 | wt % |
| Polydimethylsiloxane (manufactured by Aldrich) | 2 | wt % |

NK Ester A-TMPT

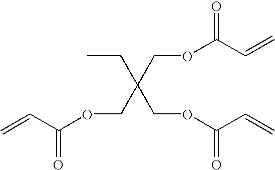

DPCA-60

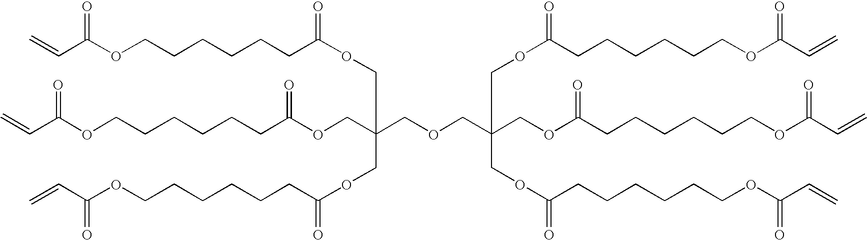

### Evaluation of Performance

The photocurable overprint compositions obtained in Examples 1 to 21 and Comparative Examples 1 to 6 were subjected to evaluation of their performance by the methods below. The evaluation results are shown in Table 1 below.

### Evaluation of Surface Smoothness (Leveling Properties)

An electrophotographically printed material, obtained using double-sided coated paper, output from a DC8000 digital printer manufactured by Fuji Xerox Co., Ltd. was coated on one side at a film thickness of 5 g/m² using an SG610V UV varnish coater manufactured by Shinano Kenshi Co., Ltd. The condition of the surface of the coated printed material was visually evaluated in terms of the occurrence of longitudinal lines.
The evaluation criteria are shown below.
Excellent: no longitudinal lines.
Good: slight longitudinal lines remained.
Fair: longitudinal lines remained but at a level that was not a problem in practice
Poor: many longitudinal lines observed at a level that caused a problem in practice

### Evaluation of Non-Tackiness (Suppression of Surface Tackiness)

An electrophotographically printed material obtained using double-sided coated paper output from a DC8000 digital printer manufactured by Fuji Xerox Co., Ltd. was coated on one side with a coating composition at a film thickness of 5 g/m² using a bar coater, and a film coating thus obtained was exposed at 120 mJ/cm² with an illumination intensity of 1.0 W/cm² using a UV lamp (LC8) manufactured by Hamamatsu Photonics K.K., thus giving an overprint sample. The non-tackiness after exposure was evaluated by touch. Evaluation criteria are shown below.
Excellent: No Tackiness
Good: almost no tackiness
Fair: slight tackiness
Poor: surface uncured

### Evaluation of Odor

An electrophotographically printed material, obtained using double-sided coated paper, output from a DC8000 digital printer manufactured by Fuji Xerox Co., Ltd. was coated on one side with the coating composition at a film thickness of 5 g/m² using an SG610V UV varnish coater manufactured by Shinano Kenshi Co., Ltd., and then allowed to stand for 1 hour, a printed material thus obtained was subjected to sensory evaluation by sensing odor, and the level of odor was evaluated according to the criteria below.

Evaluation was carried out by eight expert panelists using the criteria below (evaluation points).
Evaluation criteria (evaluation points):
5 (points): 8 out of 8 people recognized effect in reducing odor.
4 (points): 6 to 7 out of 8 people recognized effect in reducing odor.
3 (points): 4 to 5 out of 8 people recognized effect in reducing odor.
2 (points): 1 to 3 out of 8 people recognized effect in reducing odor.
1 (point) : effect in reducing odor was not recognized.

When the number of evaluation points was at least 4, it was considered that there would be no problem in practice.

TABLE 1

| | Polymerization | Surface | | |
|---|---|---|---|---|
| | initiator | smoothness | Non-tackiness | Odor |
| Ex. 1 | I-1 | Excellent | Excellent | 5 |
| Ex. 2 | I-3 | Excellent | Excellent | 5 |
| Ex. 3 | I-8 | Excellent | Excellent | 5 |
| Ex. 4 | S-1 | Excellent | Excellent | 5 |
| Ex. 5 | S-2 | Excellent | Excellent | 5 |
| Ex. 6 | S-8 | Excellent | Excellent | 5 |
| Ex. 7 | S-9 | Excellent | Excellent | 5 |
| Ex. 8 | N-2 | Excellent | Good | 5 |
| Ex. 9 | N-8 | Excellent | Good | 5 |
| Ex. 10 | N-16 | Excellent | Fair | 4 |
| Ex. 11 | I-1 | Good | Excellent | 5 |
| Ex. 12 | I-3 | Good | Excellent | 5 |
| Ex. 13 | I-8 | Good | Excellent | 5 |
| Ex. 14 | S-2 | Good | Excellent | 5 |
| Ex. 15 | S-3 | Good | Excellent | 5 |
| Ex. 16 | S-6 | Good | Excellent | 5 |
| Ex. 17 | S-8 | Good | Excellent | 5 |
| Ex. 18 | N-3 | Good | Good | 5 |
| Ex. 19 | N-9 | Good | Good | 5 |
| Ex. 20 | N-16 | Good | Fair | 4 |
| Ex. 21 | I-1 | Fair | Excellent | 4 |
| Comp. Ex. 1 | H-1 | Excellent | Fair | 1 |
| Comp. Ex. 2 | H-2 | Excellent | Fair | 1 |
| Comp. Ex. 3 | H-3 | Excellent | Poor | 1 |
| Comp. Ex. 4 | H-1 | Good | Fair | 1 |
| Comp. Ex. 5 | H-2 | Good | Fair | 1 |
| Comp. Ex. 6 | H-3 | Good | Poor | 1 |

### Example 22

21 sheets of printed material were prepared by electrophotographically printing full color images, each having a few frames, on both sides of A4 double-sided coated paper (paper weight 100 g/m²) , both sides of the printed materials were coated with the photocurable coating compositions prepared in Examples 1 to 21 above by the same method as in Example 1 at a coat weight of 5 g/m², and then irradiated with UV rays, thus giving overprints. When they were bound to give a photo album, a photo album giving the same visibility as that given by a silver halide photographic print was obtained.

### Example 23

21 sheets of printed material were prepared by electrophotographically printing a full color image including a menu photograph and text on both sides of substantially A3 double-sided coated paper (paper weight 100 g/m²), both sides of the printed materials were coated with the photocurable coating compositions prepared in Examples 1 to 21 above by the same method as in Example 1 at a coat weight of 5 g/m² per side, and then irradiated with UV rays, thus giving overprints on both sides. When they were bound to give a restaurant menu, a restaurant menu giving the same visibility as that given by a silver halide photographic print was obtained.

In Examples 1 to 21 above, the amount of overprint layer formed by coating one side of a printing substrate with a photocurable coating composition at a coat weight of 5 g/m² and curing it was 5 g/m² in each case.

Furthermore, the thickness of the overprint layer thus formed was about 5 μm in each case. The thickness of the overprint layer thus formed was measured by examining a cross section of the overprint using an optical microscope.

When the transmittance at an optical path length of 5 μm of the photocurable coating compositions used in Examples 1 to 21 was measured, the transmittance was 80% over the whole wavelength region of 400 nm to 700 nm in all cases.

When the transmittance at an optical path length of 5 μm of the cured material formed by the photocurable coating compositions used in Examples 1 to 21 was measured, the transmittance was 80% over the whole wavelength region of 400 nm to 700 nm in all cases.

What is claimed is:

1. A process for producing an overprint, the process comprising:
a step of preparing a printed material by printing on a printing substrate;
a step of coating the printed material with a photocurable composition; and
a step of photocuring the photocurable composition;
the photocurable composition comprising (A) a polymerizable group-containing photopolymerization initiator and (B) a polymerizable compound.

2. The process for producing an overprint according to claim 1, wherein the polymerizable group of the polymerizable group-containing photopolymerization initiator (A) is an ethylenically unsaturated bond and/or a cyclic ether group.

3. The process for producing an overprint according to claim 1, wherein the polymerizable group-containing photopolymerization initiator (A) is a compound selected from the group consisting of an onium salt compound, a borate salt compound, an imide structure-containing compound, a triazine structure-containing compound, an azo compound, a peroxide, and a lophine dimer structure-containing compound.

4. The process for producing an overprint according to claim 1, wherein the polymerizable group-containing photopolymerization initiator (A) is a compound selected from the group consisting of an onium salt compound, an imide structure-containing compound, and a triazine structure-containing compound.

5. The process for producing an overprint according to claim 1, wherein the photocurable composition has substantially no absorption in the visible region.

6. The process for producing an overprint according to claim 1, wherein the printing is electrophotographic printing, and the printed material is an electrophotographically printed material.

7. The process for producing an overprint according to claim 6, wherein the electrophotographically printed material is an electrophotographically printed material having a fuser oil layer.

8. The process for producing an overprint according to claim 1, wherein the amount of cured photocurable composition formed on the printed material is 1 to 10 g/m².

9. The process for producing an overprint according to claim 1, wherein the photocurable composition cured on the printed material has a thickness of 1 to 10 μm.

10. An overprint produced by the process for producing an overprint according to claim 1.

11. A photocurable composition comprising:
(A) a polymerizable group-containing photopolymerization initiator; and
(B) a polymerizable compound.

12. The photocurable composition according to claim 11, wherein the polymerizable group of the polymerizable group-containing photopolymerization initiator (A) is an ethylenically unsaturated bond and/or a cyclic ether group.

13. The photocurable composition according to claim 11, wherein the polymerizable group-containing photopolymerization initiator (A) is a compound selected from the group consisting of an onium salt compound, a borate salt compound, an imide structure-containing compound, a triazine structure-containing compound, an azo compound, a peroxide, and a lophine dimer structure-containing compound.

14. The photocurable composition according to claim 11, wherein the polymerizable group-containing photopolymerization initiator (A) is a compound selected from the group consisting of an onium salt compound, an imide structure-containing compound, and a triazine structure-containing compound.

15. The photocurable composition according to claim 11, wherein it has substantially no absorption in the visible region.
